(19) United States
(12) Patent Application Publication
(10) Pub. No.: US 2021/0024764 A1
(43) Pub. Date: Jan. 28, 2021

(54) AQUEOUS INK JET COMPOSITION

(71) Applicant: Seiko Epson Corporation, Tokyo (JP)

(72) Inventors: Michio NAKAMORI, Matsumoto (JP); Shinichi YAMAMOTO, Matsumoto (JP); Yasunari IKEDA, Shiojiri (JP)

(21) Appl. No.: 16/934,109

(22) Filed: Jul. 21, 2020

(30) Foreign Application Priority Data
Jul. 22, 2019 (JP) 2019-134805

(51) Int. Cl. C09D 11/328; C09D 11/102

(52) U.S. Cl. CPC C09D 11/328; C08K 5/45; C09D 11/102

(57) ABSTRACT

An aqueous ink jet composition of the present disclosure includes at least one specific dye selected from the group consisting of C.I. Disperse Orange 25 and C.I. Disperse Brown 27; an anionic dispersant; and a material A which is at least one compound selected from the group consisting of a polyalkylene glycol, a derivative thereof, and a phenyl azo compound different from the specific dye.

The present application is based on, and claims priority from JP Application Serial Number 2019-134805, filed Jul. 22, 2019, the disclosure of which is hereby incorporated by reference herein in its entirety.

### BACKGROUND

### 1. Technical Field

The present disclosure relates to an aqueous ink jet composition.

### 2. Related Art

In recent years, the application of ink jet printing has been increased, and besides printing by office and household printers, the ink jet printing is also applied to commercial printing, textile printing, and the like.

In addition, an ink-jet ink containing a sublimation dye, such as a disperse dye or a solvent dye, has also been used.

The ink-jet ink as described above has been used for a direct printing method in which after an ink is applied to a recording medium to be dyed, a dye is fixed by a heat treatment, such as steaming, and for a thermal transfer printing method in which after a dye ink is applied to an intermediate transfer medium, a dye is sublimation-transferred by heating from an intermediate transfer medium side to a recording medium to be dyed.

The ink-jet ink containing a disperse dye or a solvent dye has problems in that, in general, due to inferior long-term dispersion stability of a dye, storage stability of the ink is low, and ejection stability thereof by an ink jet method is also low.

In order to solve the problems as described above, an ink composition described in International Publication No. WO2005/121263 has been proposed.

However, in the ink composition as described above, when a specific disperse dye or solvent dye is contained, a sufficiently excellent storage stability of the ink composition cannot be obtained, and problems of apparent generation of foreign materials due to long-term storage and clogging of a head filter and/or a nozzle in ink ejection by an ink jet method may arise. In particular, the present inventor found that when at least one of C.I. Disperse Orange 25 and C.I. disperse Brown 27, each of which is a dye having an excellent orange to brown coloring property, is used as a dye, the problems as described above become apparent.

### SUMMARY

The present disclosure is made to solve the problems described above and can be realized as the following application examples.

An aqueous ink jet composition according an application example of the present disclosure comprises: at least one specific dye selected from the group consisting of C.I. Disperse Orange 25 and C.I. Disperse Brown 27; an anionic dispersant; and a material A which is at least one compound selected from the group consisting of a polyalkylene glycol, a derivative thereof, and a phenyl azo compound different from the specific dye.

In addition, in an aqueous ink jet composition according to another application example of the present disclosure, the anionic dispersant may be at least one of a compound represented by the following formula (3), a sodium naphthalenesulfonate formalin condensate, a ligninsulfonic acid, and a styrene-sodium styrenesulfonate copolymer.

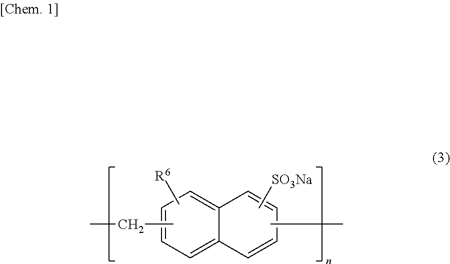

In the formula (3), R⁶ indicates a hydrocarbon group having four carbon atoms or less, and n indicates an integer of 1 or more.

In addition, in an aqueous ink jet composition according to another application example of the present disclosure, when a content of the specific dye is represented by XD [percent by mass], and a content of the anionic dispersant is represented by XB [percent by mass], 0.4≤XB/XD≤2.0 may be satisfied.

In addition, in an aqueous ink jet composition according to another application example of the present disclosure, when a content of the specific dye is represented by XD [percent by mass], and a content of the material A is represented by XA [percent by mass], 0.05≤XA/XD≤2.0 may be satisfied.

In addition, according to an aqueous ink jet composition of another application example of the present disclosure, in the aqueous ink jet composition described above, when a content of the material A is represented by XA [percent by mass], and a content of the anionic dispersant is represented by XB [percent by mass], 0.02≤XA/XB≤3.0 may be satisfied.

In addition, in an aqueous ink jet composition according to another application example of the present disclosure, the anionic dispersant may have a weight average molecular weight of 1,000 to 20,000.

In addition, in an aqueous ink jet composition according to another application example of the present disclosure, the material A may at least contain the polyalkylene glycol, and the polyalkylene glycol may have a weight average molecular weight of 1,000 to 20,000.

In addition, in an aqueous ink jet composition according to another application example of the present disclosure, the material A may at least contain the phenyl azo compound, and the phenyl azo compound may have a weight average molecular weight of 300 to 1,200.

In addition, in an aqueous ink jet composition according to another application example of the present disclosure, the material A may contain, as the phenyl azo compound, at least one selected from the group consisting of C.I. Disperse Orange 30, C.I. Disperse Orange 31, and C.I. Disperse Orange 73.

In addition, an aqueous ink jet composition according to another application example of the present disclosure may be used in an air open-type recording apparatus.

### DESCRIPTION OF EXEMPLARY EMBODIMENTS

Hereinafter, preferable embodiments of the present disclosure will be described in detail.
1 Aqueous Ink Jet Composition

Incidentally, among various sublimation dyes, although being excellent in coloring property and the like, C.I. Disperse Orange 25 and C.I. Disperse Brown 27 have the following problems. That is, in the past, when a specific dye which is at least one of C.I. Disperse Orange 25 and C.I. Disperse Brown 27 is used as a constituent component of an aqueous ink jet composition, storage stability of this aqueous ink jet composition cannot be sufficiently improved, and hence, serious problems, such as apparent generation of foreign materials due to long-term storage, and clogging of a head filter and/or a nozzle in ink ejection by an ink jet method, have occurred.

Accordingly, in order to provide an aqueous ink jet composition capable of effectively preventing generation of the problems described above while excellent features of the specific dye are secured, intensive research was performed by the present inventor.

As a result, the present disclosure was finally made.

That is, an aqueous ink jet composition of the present disclosure comprises: at least one specific dye selected from the group consisting of C.I. Disperse Orange 25 and C.I. Disperse Brown 27: an anionic dispersant: and a material A which is at least one compound selected from the group consisting of a polyalkylene glycol, a derivative thereof, and a phenyl azo compound different from the specific dye.

By the structure as described above, while the effect of the specific dye which is a dye excellent in color development in a low temperature process and the like is secured, an aqueous ink jet composition which suppresses apparent generation of foreign materials due to long-term storage and clogging of a head filter and/or a nozzle in ink ejection by an ink jet method can be provided. In addition, even when the aqueous ink jet composition is placed in a high-temperature and high-humidity environment, apparent generation of foreign materials and clogging of a head filter and/or a nozzle in ink ejection by an ink jet method can be suppressed from easily occurring.

On the other hand, when the conditions as described above are not fulfilled, a satisfactory result cannot be obtained.

For example, when the above material A is not used, the dispersion stability of the specific dye cannot be secured in the aqueous ink jet composition, and foreign materials are liable to be generated, for example, during long-term storage of the aqueous ink jet composition.

In addition, when the anionic dispersant is not used, or when another dispersant, such as a nonionic dispersant or a cationic dispersant, is used instead of using the anionic dispersant, the dispersion stability of the specific dye in the aqueous ink jet composition cannot be secured, and foreign materials are liable to be generated, for example, during long-term storage of the aqueous ink jet composition.

In addition, in this specification, the aqueous ink jet composition is a concept including, besides an ink itself to be ejected by an ink jet method, a stock solution to be used for preparation of the ink. In other words, the aqueous ink jet composition of the present disclosure may be a composition to be ejected by an ink jet method without any treatment or a composition to be ejected by an ink jet method after a treatment, such as a dilution treatment, is performed. In addition, in this specification, the aqueous ink jet composition is a composition containing at least water as a primary volatile liquid component, and the rate of the water in the volatile liquid component forming the aqueous ink jet composition is preferably 30 to 85 percent by mass, more preferably 35 to 80 percent by mass, and further preferably 40 to 75 percent by mass.

In addition, in the present disclosure, the phenyl azo compound indicates a compound having the structure represented by the following formula (1).

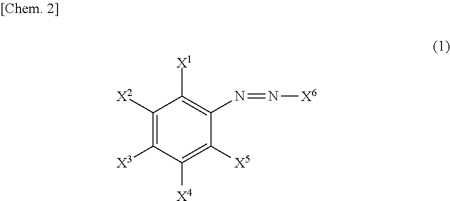

In the formula (1), X¹, X², X³, X⁴, X⁵, and X⁶ each independently indicate an arbitrary element or atomic group.
1-1 Material A

The aqueous ink jet composition of the present disclosure contains the material A which is at least one compound selected from the group consisting of a polyalkylene glycol, a derivative thereof, and a phenyl azo compound different from the specific dye. In the following description, the phenyl azo compound different from the specific dye is also simply called “the phenyl azo compound” in some cases.

When being used in combination with the specific dye and the anionic dispersant, the material A is able to improve the dispersion stability of the specific dye in the aqueous ink jet composition and the storage stability thereof, and hence, apparent generation of foreign materials due to long-term storage and clogging of a head filter and/or a nozzle in ink ejection by an ink jet method can be effectively prevented. As a result, the ejection of the aqueous ink jet composition can be stably performed for a long time, and the quality of a recorded matter formed by an ink jet method can be stably improved. In addition, the material A is a component which protects the quality of the recorded matter and sublimation dyeing from being adversely influenced.

As the material A, the aqueous ink jet composition of the present disclosure may contain either one type of compound or at least two types of compounds. In more particular, the material A may be, for example, a mixture of a polyalkylene glycol and a phenyl azo compound different from the above specific dye.

As the polyalkylene glycol, for example, there may be mentioned a polyoxyethylene, a polyoxypropylene, or a copolymer thereof.

As the derivative of the polyalkylene glycol, for example, an ether compound of the above polyalkylene glycol may be mentioned.

When the material A forming the aqueous ink jet composition is a material containing at least a polyalkylene glycol, although not particularly limited, the lower limit of the weight average weight molecular weight of the polyalkylene glycol is preferably 1,000, more preferably 5,000, and further preferably 10,000. In addition, when the material A forming the aqueous ink jet composition is a material containing at least a polyalkylene glycol, although not particularly limited, the upper limit of the weight average weight molecular weight of the polyalkylene glycol is preferably 20,000, more preferably 19,000, and further preferably 18,000.

Accordingly, the storage stability of the aqueous ink jet composition is further improved, and the generation of foreign materials, for example, during the long-term storage can be more effectively prevented.

When the material A at least contains the phenyl azo compound different from the specific dye, the lower limit of the molar mass of the phenyl azo compound is preferably 300, more preferably 320, and further preferably 350. In addition, when the material A at least contains the phenyl azo compound different from the specific dye, the upper limit of the molar mass of the phenyl azo compound is preferably 1,200, more preferably 700, and further preferably 450.

Accordingly, apparent generation of foreign materials due to long-term storage and clogging of a head filter and/or a nozzle in ink ejection by an ink jet method can be more effectively prevented.

As the phenyl azo compound which is different from the specific dye and which forms the material A, for example, there may be mentioned C.I. Food Orange 1, 2, 3, 4, or 4:1, C.I. Acid Orange 1, 10, 10:1, 100, 12, 125, 127, 134, 137, 14, 142, 144, 148, 154, 159, 16, 160, 164, 17, 173, 18, 19, 20, 23, 27, 28, 30, 31, 41, 5, 51, 52, 56, 60, 61, 62, 7, 72, 74, 76, 8, 86, 87, 88, 88:1, 89, 9, 92, 97, or 98, C.I. Basic Orange 1, 2, 24, 25, 29, 30, 33, 54, or 69, C.I. Direct Orange 17, 18, 75, 84, or 85, C.I. Disperse Orange 1, 1:1, 10, 127, 138, 149, 152, 157, 17, 18, 23, 25:1, 3, 3:1, 30, 31, 33, 36, 37, 41, 42, 44, 49, 5, 50, 52, 53, 56, 57, 61, 62, 67, 68, 7, 71, 73, 76, 78, 80, 90, 96, or 97, C.I. Reactive Orange 1, 107, 113, 116, 118, 119, 12, 122, 123, 124, 125, 126, 13, 134, 135, 139, 14, 16, 2, 29, 3, 33, 35, 37, 38, 4, 5, 56, 64, 67, 68, 7, 70, 72, 72:1, 82, 84, 86, 87, 91, 94, 95, or 96, C.I. Solvent Orange 1, 102, 103, 105, 11, 110, 12, 2, 20, 3, 4, 4:1, 40:1, 41, 45, 49, 5, 54, 56, 6, 62, 7, 75, 8, 81, 9, 98, or 99, C.I. Acid Red 6, 18, 57, 97, 106, 151, 249, or 260, or C.I. Acid Yellow 17, 19, 42, 49, or 79. Although those dyes mentioned above may be used alone, or at least two types thereof may be used in combination, the material A preferably contains, as the phenyl azo compound different from the specific dye, at least one selected from the group consisting of C.I. Disperse Orange 30, C.I. Disperse Orange 31, and C.I. Disperse Orange 73.

Accordingly, apparent generation of foreign materials due to long-term storage and clogging of a head filter and/or a nozzle in ink ejection by an ink jet method can be more effectively prevented.

When the rate of the three components described above with respect to the total material A contained in the aqueous ink jet composition, that is, when the rate of the total contents of C.I. Disperse Orange 30, C.I. Disperse Orange 31, and C.I. Disperse Orange 73 with respect to the content of the total material A, is 40 percent by mass or more, the effects described above can be significantly obtained, and when the rate described above is 50 percent by mass or more, the effects described above can be more significantly obtained.

Although not particularly limited, the lower limit of the content of the material A in the aqueous ink jet composition is preferably 0.05 percent by mass, more preferably 0.1 percent by mass, and further preferably 0.2 percent by mass. In addition, although not particularly limited, the upper limit of the content of the material A in the aqueous ink jet composition is preferably 10 percent by mass, more preferably 8 percent by mass, and further preferably 5 percent by mass.

Accordingly, the storage stability of the aqueous ink jet composition is further improved, and the generation of foreign materials, for example, during the long-term storage can be more effectively prevented.

In particular, when the aqueous ink jet composition is an ink itself to be ejected by an ink jet method, although not particularly limited, the lower limit of the content of the material A in the ink is preferably 0.05 percent by mass, more preferably 0.1 percent by mass, and further preferably 0.2 percent by mass. In addition, when the aqueous ink jet composition is an ink itself to be ejected by an ink jet method, although not particularly limited, the upper limit of the content of the material A in the ink is preferably 8.0 percent by mass, more preferably 5.0 percent by mass, and further preferably 3.0 percent by mass.

In addition, when the aqueous ink jet composition is a stock solution to be used for preparation of an ink ejected by an ink jet method, although not particularly limited, the lower limit of the content of the material A in the stock solution is preferably 0.1 percent by mass, more preferably 0.2 percent by mass, and further preferably 0.3 percent by mass. In addition, when the aqueous ink jet composition is a stock solution to be used for preparation of an ink ejected by an ink jet method, although not particularly limited, the upper limit of the content of the material A in the stock solution is preferably 10 percent by mass, more preferably 8 percent by mass, and further preferably 5 percent by mass.

In addition, when the material A forming the aqueous ink jet composition contains at least two types of compounds, as the content thereof, the sum of the contents of the at least two types of compounds is to be used.
1-2 Anionic Dispersant

The aqueous ink jet composition of the present disclosure contains the anionic dispersant.

In addition, the aqueous ink jet composition may contain at least two types of anionic dispersants.

Although the anionic dispersant is not particularly limited as long as being ionized into an anion, at least one of the compound represented by the following formula (3), a sodium naphthalenesulfonate formalin condensate, a ligninsulfonic acid, and a styrene-sodium styrenesulfonate copolymer is preferable.

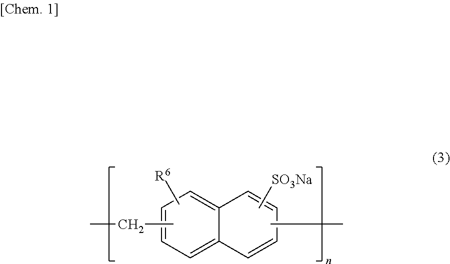

In the formula (3), R⁶ represents a hydrocarbon group having four carbon atoms or less, and n represents an integer of one or more.

Those four types of compounds, that is, the compound represented by the above formula (3), the sodium naphthalenesulfonate formalin condensate, the ligninsulfonic acid, and the styrene-sodium styrenesulfonate copolymer, have common partial chemical structures, such as a sulfo group or a salt thereof, and an aromatic ring, and hence have common characteristics. In addition, since at least one of the compound represented by the above formula (3), the sodium naphthalenesulfonate formalin condensate, the ligninsulfonic acid, and the styrene-sodium styrenesulfonate copolymer is used, a hydrophobic property of the dispersant is improved, adsorption of the dispersant to the specific dye is promoted, and the long-term stability of the aqueous ink jet composition is further improved.

Although R⁶ in the formula (3) may be a hydrocarbon group having four carbon atoms or less, in particular, a hydrocarbon group having two carbon atoms or less is preferable.

Accordingly, the balance between the hydrophobic property and the hydrophilic property of the anionic dispersant can be made more preferable, and the dispersion stability of the specific dye in the aqueous ink jet composition can be further improved.

Although not particularly limited, the lower limit of a weight average molecular weight Mw of the anionic dispersant is preferably 1,000, more preferably 2,000, and further preferably 3,000. In addition, although not particularly limited, the upper limit of the weight average molecular weight Mw of the anionic dispersant is preferably 20,000, more preferably 10,000, and further preferably 5,000.

Accordingly, the storage stability of the aqueous ink jet composition is further improved, and the generation of foreign materials, for example, during the long-term storage can be more effectively prevented.

Although not particularly limited, the lower limit of the content of the anionic dispersant in the aqueous ink jet composition is preferably 0.1 percent by mass, more preferably 1.0 percent by mass, and further preferably 2.0 percent by mass. In addition, although not particularly limited, the upper limit of the content of the anionic dispersant in the aqueous ink jet composition is preferably 30 percent by mass, more preferably 25 percent by mass, and further preferably 20 percent by mass.

Accordingly, the storage stability of the aqueous ink jet composition is further improved, and the generation of foreign materials, for example, during the long-term storage can be more effectively prevented.

In particular, when the aqueous ink jet composition is an ink itself to be ejected by an ink jet method, the lower limit of the content of the anionic dispersant in the ink is preferably 0.1 percent by mass, more preferably 1.0 percent by mass, and further preferably 2.0 percent by mass. In addition, when the aqueous ink jet composition is an ink itself to be ejected by an ink jet method, the upper limit of the content of the anionic dispersant in the ink is preferably 20 percent by mass, more preferably 15 percent by mass, and further preferably 10 percent by mass.

In addition, when the aqueous ink jet composition is a stock solution to be used for preparation of an ink ejected by an ink jet method, the lower limit of the content of the anionic dispersant in the stock solution is preferably 5.0 percent by mass, more preferably 6.0 percent by mass, and further preferably 7.0 percent by mass. In addition, when the aqueous ink jet composition is a stock solution to be used for preparation of an ink ejected by an ink jet method, the upper limit of the content of the anionic dispersant in the stock solution is preferably 30 percent by mass, more preferably 25 percent by mass, and further preferably 20 percent by mass.

In addition, when the anionic dispersant forming the aqueous ink jet composition contains at least two types of compounds, as the content thereof, the sum of the contents of the at least two types of compounds is to be used.
1-3 Specific Dye

The aqueous ink jet composition contains at least one specific dye selected from the group consisting of C.I. Disperse Orange 25 and C.I. Disperse Brown 27.

Although having similar color tones to each other, that is, although having orange to brown color tones, those two types of dyes can be appropriately used in combination to adjust a composition of the specific dye in accordance with, for example, a color tone required for the recorded matter.

Although not particularly limited, the lower limit of the average particle diameter of the specific dye in the aqueous ink jet composition is preferably 50 nm, more preferably 75 nm, and further preferably 100 nm. In addition, although not particularly limited, the upper limit of the average particle diameter of the specific dye in the aqueous ink jet composition is preferably 300 nm, more preferably 250 nm, and further preferably 200 nm.

Accordingly, the storage stability of the aqueous ink jet composition is further improved, and the generation of foreign materials, for example, during the long-term storage can be more effectively prevented. In addition, a recording portion formed using the aqueous ink jet composition can be more effectively sublimated, and the aqueous ink jet composition can be more preferably applied to the sublimation dyeing.

In addition, in this specification, the average particle diameter indicates a volume-based average particle diameter unless otherwise particularly noted. The average particle diameter may be obtained by measurement, for example, using a Microtrac UPA (manufactured by Nikkiso Co., Ltd.).

Although not particularly limited, the lower limit of the content of the specific dye in the aqueous ink jet composition is preferably 0.1 percent by mass, more preferably 2.0 percent by mass, and further preferably 3.0 percent by mass. In addition, although not particularly limited, the upper limit of the content of the specific dye in the aqueous ink jet composition is preferably 35 percent by mass, more preferably 25 percent by mass, and further preferably 20 percent by mass.

Accordingly, in a recording portion formed using the aqueous ink jet composition, a higher color density can be obtained, and in addition, the storage stability of the aqueous ink jet composition is further improved, and the generation of foreign materials, for example, during the long-term storage can be more effectively prevented.

In particular, when the aqueous ink jet composition is an ink itself to be ejected by an ink jet method, the lower limit of the content of the specific dye in the ink is preferably 0.1 percent by mass, more preferably 2.0 percent by mass, and further preferably 3.0 percent by mass. In addition, when the aqueous ink jet composition is an ink itself to be ejected by an ink jet method, the upper limit of the content of the specific dye in the ink is preferably 15 percent by mass, more preferably 10 percent by mass, and further preferably 8.0 percent by mass.

In addition, when the aqueous ink jet composition is a stock solution to be used for preparation of an ink ejected by an ink jet method, the lower limit of the content of the specific dye in the stock solution is preferably 7.0 percent by mass, more preferably 10 percent by mass, and further preferably 12 percent by mass. In addition, when the aqueous ink jet composition is a stock solution to be used for preparation of an ink ejected by an ink jet method, the upper limit of the content of the specific dye in the stock solution is preferably 35 percent by mass, more preferably 25 percent by mass, and further preferably 20 percent by mass.

As the specific dye contained in the aqueous ink jet composition, although at least one selected from the group consisting of C.I. Disperse Orange 25 and C.I. Disperse Brown 27 may be used, C.I. Disperse Orange 25 is preferably at least contained and is more preferably contained as a primary component.

Accordingly, in a recording portion formed using the aqueous ink jet composition, a higher color density can be obtained, and in addition, the storage stability of the aqueous ink jet composition is further improved, and the generation of foreign materials, for example, during the long-term storage can be more effectively prevented.

The rate of C.I. Disperse Orange 25 in the specific dye contained in the aqueous ink jet composition is preferably 50 percent by mass or more, more preferably 80 percent by mass or more, and further preferably 90 percent by mass or more.

Accordingly, the effects described above can be more significantly obtained.

Although not particularly limited, the lower limit of the content of C.I. Disperse Orange 25 in the aqueous ink jet composition is preferably 0.1 percent by mass, more preferably 1.0 percent by mass, and further preferably 1.5 percent by mass. In addition, although not particularly limited, the upper limit of the content of C.I. Disperse Orange 25 in the aqueous ink jet composition is preferably 30 percent by mass, more preferably 22 percent by mass, and further preferably 20 percent by mass.

Accordingly, in a recording portion formed using the aqueous ink jet composition, a higher color density can be obtained, and in addition, the storage stability of the aqueous ink jet composition is further improved, and the generation of foreign materials, for example, during the long-term storage can be more effectively prevented.

In particular, when the aqueous ink jet composition is an ink itself to be ejected by an ink jet method, the lower limit of the content of C.I. Disperse Orange 25 in the ink is preferably 0.1 percent by mass, more preferably 2.0 percent by mass, and further preferably 3.0 percent by mass. In addition, when the aqueous ink jet composition is an ink itself to be ejected by an ink jet method, although not particularly limited, the upper limit of the content of C.I. Disperse Orange 25 in the ink is preferably 12 percent by mass, more preferably 9.0 percent by mass, and further preferably 8.0 percent by mass.

In addition, when the aqueous ink jet composition is a stock solution to be used for preparation of an ink ejected by an ink jet method, the lower limit of the content of C.I. Disperse Orange 25 in the stock solution is preferably 7.0 percent by mass, more preferably 10 percent by mass, and further preferably 12 percent by mass. In addition, when the aqueous ink jet composition is a stock solution to be used for preparation of an ink ejected by an ink jet method, the upper limit of the content of C.I. Disperse Orange 25 in the stock solution is preferably 30 percent by mass, more preferably 22 percent by mass, and further preferably 20 percent by mass.

In addition, when the content of the specific dye forming the aqueous ink jet composition is represented by XD [percent by mass], and the content of the material A therein is represented by XA [percent by mass], although not particularly limited, the lower limit of XA/XD is preferably 0.05, more preferably 0.06, and further preferably 0.07. In addition, although not particularly limited, the upper limit of XA/XD is preferably 2.0, more preferably 1.5, and further preferably 1.0.

Accordingly, the storage stability of the aqueous ink jet composition is further improved, and the generation of foreign materials, for example, during the long-term storage can be more effectively prevented.

In addition, when the content of the specific dye forming the aqueous ink jet composition is represented by XD [percent by mass], and the content of the anionic dispersant therein is represented by XB [percent by mass], although not particularly limited, the lower limit of XB/XD is preferably 0.4, more preferably 0.5, and further preferably 0.6. In addition, although not particularly limited, the upper limit of XB/XD is preferably 2.0, more preferably 1.5, and further preferably 1.2.

Accordingly, the storage stability of the aqueous ink jet composition is further improved, and the generation of foreign materials, for example, during the long-term storage can be more effectively prevented.

In the aqueous ink jet composition, when the content of the material A is represented by XA [percent by mass], and the content of the anionic dispersant is represented by XB [percent by mass], although not particularly limited, the lower limit of XA/XB is preferably 0.02, more preferably 0.03, and further preferably 0.05. In addition, although not particularly limited, the upper limit of XA/XB is preferably 3.0, more preferably 2.0, and further preferably 1.0.

Accordingly, the storage stability of the aqueous ink jet composition is further improved, and the generation of foreign materials, for example, during the long-term storage can be more effectively prevented.
1-4 Water

The aqueous ink jet composition contains water. As this water, for example, purified water, such as reverse osmosis (RO) water, distilled water, or ion-exchanged water, may be used.

Although not particularly limited, the lower limit of the content of the water in the aqueous ink jet composition is preferably 30 percent by mass, more preferably 35 percent by mass, and further preferably 40 percent by mass. In addition, although not particularly limited, the upper limit of the content of the water in the aqueous ink jet composition is preferably 85 percent by mass, more preferably 80 percent by mass, and further preferably 75 percent by mass.

Accordingly, the viscosity of the aqueous ink jet composition can be more reliably controlled at a preferable value, and the ejection stability by an ink jet method can be further improved.
1-5 Other Dye Components

The aqueous ink jet composition may also contain, besides the specific dye and the phenyl azo compound forming the material A, that is, the phenyl azo compound different from the specific dye, at least one dye component.

Although the dye component mentioned above is not particularly limited, and for example, various disperse dyes and solvent dyes other than the specific dye and the phenyl azo compound forming the material A may be mentioned, at least one selected from the group consisting of C.I. Disperse Blue 360, C.I. Disperse Yellow 54, and C.I. Solvent Orange 60 is preferable.

Accordingly, the specific dye can be preferably made to function as a complementary color of at least one selected from the group consisting of C.I. Disperse Blue 360, C.I. Disperse Yellow 54, and C.I. Solvent Orange 60.
1-6 Solvent Other than Water

The aqueous ink jet composition may contain at least one solvent other than the water.

Accordingly, the viscosity of the aqueous ink jet composition can be preferably adjusted, and a moisture-retention property of the aqueous ink jet composition can be improved. As a result, liquid drop ejection by an ink jet method can be more stably performed.

As the solvent other than the water contained in the aqueous ink jet composition, for example, glycerin, propylene glycol, or 2-pyrrolidone may be mentioned.

Since at least one of those solvents is contained, an evaporation rate can be decreased because of an excellent moisture-retention property, and hence, stabler liquid drop ejection can be performed.

Although not particularly limited, the lower limit of the content of the solvent other than the water contained in the aqueous ink jet composition is preferably 0 percent by mass, more preferably 10 percent by mass, and further preferably 15 percent by mass. In addition, although not particularly limited, the upper limit of the content of the solvent other than the water contained in the aqueous ink jet composition is preferably 45 percent by mass, more preferably 43 percent by mass, and further preferably 40 percent by mass.

Accordingly, the effect of the solvent other than the water described above can be more significantly obtained.
1-7 Surfactant

The aqueous ink jet composition may also contain a surfactant.

Accordingly, wettability of the aqueous ink jet composition to a recording medium can be further improved, and hence, a more preferable image quality can be advantageously obtained.

As the surfactant contained in the aqueous ink jet composition, for example, various types of surfactants, such as an anionic surfactant, a cationic surfactant, and a nonionic surfactant, may be used.

In more particular, as the surfactant contained in the aqueous ink jet composition, for example, an acetylene-based surfactant, a silicone-based surfactant, or a fluorine-based surfactant may be mentioned.

When the aqueous ink jet composition contains a silicone-based surfactant, the wettability of the aqueous ink jet composition to a recording medium can be further improved, and a recording portion having a more excellent tone gradation property can be formed.

When the aqueous ink jet composition contains a silicone-based surfactant, although not particularly limited, the lower limit of the content of the silicone-based surfactant in the aqueous ink jet composition is with respect to 100 parts by mass of the specific dye, preferably 5.0 parts by mass, more preferably 7.0 parts by mass, and further preferably 10.0 parts by mass. Although not particularly limited, the upper limit of the content of the silicone-based surfactant in the aqueous ink jet composition is with respect to 100 parts by mass of the specific dye, preferably 150 parts by mass, more preferably 140 parts by mass, and further preferably 70 parts by mass.

Accordingly, the effect of the silicone-based surfactant described above can be more significantly obtained.

As a commercially available silicone-based surfactant, for example, there may be mentioned BYK-306, BYK-307, BYK-333, BYK-337, BYK-341, BYK-345, BYK-346, BYK-347, BYK-348, BYK-349, or BYK-378(trade name, manufactured by BYK Japan KK); or KF-351A, KF-352A, KF-353, KF-354L, KF-355A, KF-615A, KF-945, KF-640, KF-642, KF-643, KF-6020, X-22-4515, KF-6011, KF-6012, KF-6015, or KF-6017(trade name, manufactured by Shin-Etsu Chemical Co., Ltd.).
1-8 Other Components

The aqueous ink jet composition may also contain at least one component other than the components described above. Hereinafter, the component as described above may also be called other components.

As the other components, for example, there may be mentioned a dispersant other than that described above; a penetrant, such as triethylene glycol monomethyl ether, triethylene glycol monobutyl ether, diethylene glycol monomethyl ether, 1,2-hexanediol, 1,2-pentandiol, 1,2-butanediol, or 3-methyl-1,5-penetandiol; a pH adjuster, a chelating agent, such as ethylenediaminetetraacetic acid salt, a fungicide/antiseptic agent, and/or a antirust agent. As the fungicide/antiseptic agent, for example, a compound having in its molecule, an isothiazolin cyclic structure may be preferably used.

The content of the other components is preferably 6 percent by mass or less and more preferably 5 percent by mass or less. In addition, as the other components, when at least two types of components are contained, the sum of the contents thereof is preferable to satisfy the above condition.

In particular, when the aqueous ink jet composition of the present disclosure contains a dispersant other than that described above, the content of this dispersant is preferably 5 percent by mass or less and more preferably 3 percent by mass or less.

Although not particularly limited, the lower limit of the surface tension of the aqueous ink jet composition at 25° C. is preferably 20 mN/m, more preferably 21 mN/m, and further preferably 23 mN/m. In addition, although not particularly limited, the upper limit of the surface tension of the aqueous ink jet composition at 25° C. is preferably 50 mN/m, more preferably 40 mN/m, and further preferably 30 mN/m.

Accordingly, for example, clogging of a nozzle of an ejection device by an ink jet method is more unlikely to occur, and the ejection stability of the aqueous ink jet composition is further improved. In addition, even if the clogging of a nozzle occurs, when the nozzle is capped, that is, when capping is performed, the recovery property can be further improved.

In addition, as the surface tension, a value measured by Wilhelmy method may be used. For the measurement of the surface tension, for example, a surface tension meter, such as CBVP-7 manufactured by Kyowa Interface Science Co., Ltd., may be used.

Although not particularly limited, the lower limit of the viscosity of the aqueous ink jet composition at 25° C. is preferably 2 mPa·s, more preferably 3 mPa·s, and further preferably 4 mPa·s. In addition, although not particularly limited, the upper limit of the viscosity of the aqueous ink jet composition at 25° C. is preferably 30 mPa·s, more preferably 20 mPa·s, and further preferably 10 mPa·s.

Accordingly, the ejection stability of the aqueous ink jet composition is further improved.

In addition, the viscosity can be measured at 25° C. using a viscoelastic tester, such as MCR-300 manufactured by Pysica, such that the shear rate is increased from 10 [s⁻¹] to 1,000 [s⁻¹], and a viscosity at a shear rate of 200 is read.

When the aqueous ink jet composition of the present disclosure is an ink, in general, this ink is received in a container, such as a cartridge, a bag, or a tank, and is then applied to a recording apparatus which uses an ink jet method. In other words, the recording apparatus according to the present disclosure includes a container, such as an ink cartridge, receiving the aqueous ink jet composition of the present disclosure as an ink.

The aqueous ink jet composition of the present disclosure may be an ink to be ejected by an ink jet method or a stock solution to be used for preparation of the ink, and although a concrete structure of an apparatus which ejects liquid droplets is not limited, the aqueous ink jet composition of the present disclosure is preferably applied to an air open-type recording apparatus and, in more particular, to an ink jet recording apparatus which includes, for example, an ink container having an ink charge port through which an ink can be replenished and a recording head having nozzle holes which eject the ink described above.

In the recording apparatus as described above, when an ink containing the specific dye is used, since the ink is in contact with the air, a problem in that foreign materials are particularly liable to be generated at a gas-liquid interface may arise; however, according to the present disclosure, even when the above ink containing the specific dye is applied to the recording apparatus as described above, the problem as described above can be effectively prevented from being generated. That is, when the aqueous ink jet composition of the present disclosure is applied to an air open-type recording apparatus, the advantage of the present disclosure can be more significantly obtained.
2 Recording Method

Although the aqueous ink jet composition of the present disclosure may be applied, for example, to a direct printing method or a thermal transfer printing method, such as sublimation dyeing, since the specific dye has a sublimation property, the aqueous ink jet composition of the present disclosure can be preferably applied to a thermal transfer printing method.

Hereinafter, as a recording method using the aqueous ink jet composition of the present disclosure, a thermal transfer printing method, in particular, one example of the sublimation dyeing, will be described.

A recording method of this embodiment includes an ink adhesion step of adhering an aqueous ink jet composition to an intermediate transfer medium by an ink jet method and a transfer step of heating the intermediate transfer medium to which the aqueous ink jet composition is adhered to transfer a specific dye contained in the aqueous ink jet composition as a sublimation dye to a recording medium.
2-1 Ink Adhesion Step

In the ink adhesion step, by an ink jet method, the aqueous ink jet composition is adhered to the intermediate transfer medium. The ejection of the aqueous ink jet composition by an ink jet method can be performed using a known ink jet recording apparatus. As an ejection method, for example, there may be used a piezoelectric method or a method in which an ink is ejected by bubbles generated by heating the ink. In particular, for example, since deterioration of the aqueous ink jet composition hardly occurs, a piezoelectric method is preferable.

In the ink adhesion step, an ink other than the aqueous ink jet composition according to the present disclosure may also be used in combination.
2-2 Intermediate Transfer Medium

As the intermediate transfer medium, for example, paper, such as regular paper, or a recording medium provided with an ink receiving layer may be used, and in more particular, for example, ink jet exclusive paper or a recording medium called coat paper or the like may be used. Among those mentioned above, paper provided with an ink receiving layer formed of inorganic particles, such as silica, is preferable. Accordingly, in a step in which the aqueous ink jet composition adhered to the intermediate transfer medium is dried, an intermediate transfer medium in which, for example, blurring is suppressed can be obtained. In addition, in the following transfer step, the sublimation of the specific dye tends to be more smoothly performed.
2-3 Transfer Step

Subsequently, the intermediate transfer medium to which the aqueous ink jet composition is adhered is heated, and the specific dye used as a constituent element of the aqueous ink jet composition is transferred to the recording medium. As a result, a recorded matter is obtained.

Although not particularly limited, the lower limit of a heating temperature in this step is preferably 160° C. and more preferably 170° C. In addition, although not particularly limited, the upper limit of the heating temperature in this step is preferably 220° C. and more preferably 200° C.

Accordingly, energy required for the transfer can be further decreased, and the productivity of the recorded matter can be further improved. In addition, the coloring property of the recorded matter thus obtained can be further improved.

Although depending on the heating temperature, the lower limit of a heating time in this step is preferably 30 seconds and more preferably 45 seconds. In addition, the upper limit of the heating time in this step is preferably 90 seconds and more preferably 80 seconds.

Accordingly, the energy required for the transfer can be further decreased, and the productivity of the recorded matter can be further improved. In addition, the coloring property of the recorded matter thus obtained can be further improved.

In addition, this step may be performed such that the surface of the intermediate transfer medium to which the aqueous ink jet composition is adhered is heated while being separated from the recording medium by a predetermined distance or while being in close contact with the surface of the recording medium; however, this step is preferably performed in the state in which the surface of the intermediate transfer medium to which the aqueous ink jet composition is adhered is in close contact with the surface of the recording medium.

Accordingly, the energy required for the transfer can be further decreased, and the productivity of the recorded matter can be further improved. In addition, the coloring property of the recorded matter thus obtained can be further improved.
2-4 Recording Medium

Although the recording medium is not particularly limited, for example, there may be mentioned a cloth, such as a hydrophobic fiber cloth, a resin film, paper, glass, a metal, or a ceramic. In addition, as the recording medium, a material having a steric shape, such as a sheet shape, a spherical shape, or a rectangular parallelepiped shape, may also be used.

When the recording medium is a cloth, as fibers forming the cloth, for example, there may be mentioned polyester fibers, nylon fibers, triacetate fibers, diacetate fibers, polyamide fibers, or a blend using at least two types of the fibers mentioned above. In addition, there may also be used a blend using the fibers mentioned above with regenerated fibers, such as rayon, or a blend using the fibers mentioned above with natural fibers, such as cotton, silk, or wool.

In addition, when the recording medium is a resin film, as the resin film mentioned above, for example, a polyester film, a polyurethane film, a polycarbonate film, a poly(phenylene sulfide) film, a polyimide film, or a poly(amide imide) film may be mentioned.

In addition, the resin film may be a laminate formed by laminating a plurality of layers or may be a gradient material in which the composition of a material is gradiently changed.

Heretofore, although the preferable embodiments of the present disclosure have been described, the present disclosure is not limited thereto.

For example, the aqueous ink jet composition of the present disclosure may be a composition to be ejected by an ink jet method and may be a composition not applied to the recording method as described above.

For example, the aqueous ink jet composition of the present disclosure may also be a composition to be applied to a method including, besides the steps described above, at least one another step.

In the case described above, as a pre-treatment step, for example, a step of applying a coat layer to the recording medium may be mentioned.

In addition, as an intermediate treatment step, for example, a step of pre-heating the recording medium may be mentioned.

In addition, as a post-treatment step, for example, a step of washing the recording medium may be mentioned.

In addition, the aqueous ink jet composition of the present disclosure can also be preferably applied to sublimation transfer which uses no intermediate transfer medium. As the sublimation transfer which uses no intermediate transfer medium, for example, there may be mentioned a method including a step of adhering an aqueous ink jet composition by an ink jet method to a strippable ink receiving layer provided on a recording medium; a step of heating the above recording medium which is provided with the ink receiving layer to which the aqueous ink jet composition is adhered so as to perform sublimation diffusion dyeing from the ink receiving layer to the recording medium disposed thereunder; and a step of peeling off the ink receiving layer from the recording medium to obtain a recorded matter.

### EXAMPLES

Next, concrete Examples of the present disclosure will be described.
3 Preparation of Stock Solution for Ink-Jet Ink Production as Aqueous Ink Jet Composition

### Example A1

First, C.I. Disperse Orange 25 as the specific dye, a sodium methylnaphthalenesulfonate formalin condensate as the anionic dispersant, C.I. Disperse Orange 73, Newpole PE-108 which was a polyethylene glycol having a weight average molecular weight of 16,000, and purified water were mixed at a ratio shown in Table 1 and then stirred at 3,000 rpm by a High Shear Mixer (manufactured by Silverson Machines Inc.), so that a slurry was obtained. C.I. Disperse Orange 73 and Newpole PE-108 were each the material A.

Subsequently, the slurry thus formed and glass beads having a diameter of 0.5 mm were dispersed and stirred under water cooling conditions by a bead mill (LMZ015, manufactured by Ashizawa Finetech Ltd.), so that a stock solution for ink-jet ink production was formed as the aqueous ink jet composition.

The average particle diameter of the specific dye in the stock solution for ink-jet ink production was 150 nm.

### Examples A2 to A37

Except for that the types of specific dyes, materials A, and anionic dispersants and the mixing ratios of the individual components were set as shown in Tables 1, 2, and 3, stock solutions for ink-jet ink production were formed as the aqueous ink jet compositions in a manner similar to that of Example A1.

### Comparative Examples A1 to A6

Except for that the types of individual components and the mixing ratios thereof were set as shown in Table 3, stock solutions for ink-jet ink production were formed as the aqueous ink jet compositions in a manner similar to that of Example A1.

The compositions of the stock solutions for ink-jet ink production of the above Examples and Comparative Examples are shown in Tables 1, 2, and 3. In addition, in the stock solution for ink-jet ink production, when the content of the material A, the content of the anionic dispersant, and the content of the specific dye are represented by XA [percent by mass], XB [percent by mass], and XD [percent by mass], respectively, values of XB/XD, XA/XD, and XA/XB are shown in Tables 4 and 5. In addition, in the tables, C.I. Disperse Orange 25 is represented by “DO25”, and C.I. Disperse Brown 27 is represented by “DB27”; a sodium methylnaphthalenesulfonate formalin condensate as the anionic dispersant is represented by “B1”, a sodium ethylnaphthalenesulfonate formalin condensate as the anionic dispersant is represented by “B2”, a sodium propylnaphthalenesulfonate formalin condensate as the anionic dispersant is represented by “B3”, a sodium butylnaphthalenesulfonate formalin condensate as the anionic dispersant is represented by “B4”, a sodium naphthalenesulfonate formalin condensate as the anionic dispersant is represented by “B5”, a sodium ligninsulfonate as the anionic dispersant is represented by “B6”, and a styrene-sodium styrenesulfonate copolymer as the anionic dispersant is represented by “B7”; a polyethylene glycol, that is, Newpole PE-34 (manufactured by Sanyo Chemical Industries, Ltd.) as a component forming the material A, is represented by “A1”, a polyethylene glycol, that is, Newpole PE-68 (manufactured by Sanyo Chemical Industries, Ltd.) as a component forming the material A, is represented by “A2”, a polyethylene glycol, that is, Newpole PE-108 (manufactured by Sanyo Chemical Industries, Ltd.) as a component forming the material A, is represented by “A3”, a polyethylene glycol, that is, Newpole PE-128 (manufactured by Sanyo Chemical Industries, Ltd.) as a component forming the material A, is represented by “A4”, a polyethylene glycol derivative, that is, NIKKOL PBC-34 (manufactured by Nikko Chemicals Co., Ltd.) as a component forming the material A, is represented by “A5”, a phenyl azo compound different from the specific dye, that is, C.I. Disperse Orange 30 as a component forming the material A, is represented by “A6”, a phenyl azo compound different from the specific dye, that is, C.I. Disperse Orange 31 as a component forming the material A, is represented by “A7”, a phenyl azo compound different from the specific dye, that is, C.I. Disperse Orange 73 as a component forming the material A, is represented by “A8”, a phenyl azo compound different from the specific dye, that is, C.I. Disperse Orange 3 as a component forming the material A, is represented by “A9”, a phenyl azo compound different from the specific dye, that is, C.I. Direct Orange 85 as a component forming the material A, is represented by “A10”, a phenyl azo compound different from the specific dye, that is, C.I. Reactive Orange 84 as a component forming the material A, is represented by “A11”, a phenyl azo compound different from the specific dye, that is, C.I. Acid Orange 7 as a component forming the material A, is represented by “A12”, a phenyl azo compound different from the specific dye, that is, C.I. Acid Orange 10 as a component forming the material A, is represented by “A13”, a phenyl azo compound different from the specific dye, that is, C.I. Acid Orange 56 as a component forming the material A, is represented by “A14”, and a phenyl azo compound different from the specific dye, that is, C.I. Acid Yellow 17 as a component forming the material A, is represented by “A15”; C.I. Disperse Orange 11 which is a dye other than the phenyl azo compound is represented by “DO11”, C.I. Disperse Orange 119 which is a dye other than the phenyl azo compound is represented by “DO119”, and C.I. Disperse Orange 15 which is a dye other than the phenyl azo compound is represented by “DO15”; and a polyoxyethylene sorbitan fatty acid ester (Solbon T-40, manufactured by Toho Chemical Industry Co., Ltd.) as a nonionic dispersant is represented by “B′1”, and a polycarboxylic acid-based surfactant (Carrybon L-400, manufactured by Sanyo Chemical Industries, Ltd.) is represented by “A′1”.

In addition, the weight average molecular weight of Newpole PE-34 as a component forming the material A is 1,700, the weight average molecular weight of Newpole PE-68 as a component forming the material A is 8,000, the weight average molecular weight of Newpole PE-108 as a component forming the material A is 16,000, and the weight average molecular weight of Newpole PE-128 as a component forming the material A is 20,000; the molecular weight of C.I. Disperse Orange 30 as a component forming the material A is 450.27, the molecular weight of C.I. Disperse Orange 31 as a component forming the material A is 381.39, the molecular weight of C.I. Disperse Orange 73 as a component forming the material A is 443.45, the molecular weight of C.I. Disperse Orange 3 as a component forming the material A is 242.23, the molecular weight of C.I. Direct Orange 85 as a component forming the material A is 1,188.93, the molecular weight of C.I. Reactive Orange 84 as a component forming the material A is 1,850.29, the molecular weight of C.I. Acid Orange 7 as a component forming the material A is 350.33, the molecular weight of C.I. Acid Orange 10 as a component forming the material A is 452.37, the molecular weight of C.I. Acid Orange 56 as a component forming the material A is 728.66, and the molecular weight of C.I. Acid Yellow 17 as a component forming the material A is 551.29. In addition, the weight average molecular weights of the anionic dispersants used in individual Examples were in a range of 1,000 to 20,000.

In addition, the stock solutions for ink-jet ink production of Examples A1 to A37 each had a viscosity in a range of 2.0 to 30 mPa·S and each had a surface tension in a range of 25 to 60 mN/m. In addition, the viscosity was measured at 25° C. using a viscoelastic tester MCR-300 (manufactured by Pysica) such that the shear rate was increased from 10 [s⁻¹] to 1,000 [s⁻¹], and a viscosity at a shear rate of 200 was read. In addition, the surface tension was measured at 25° C. by a Wilhelmy method using a surface tension meter (CBVP-7, manufactured by Kyowa Interface Science Co., Ltd.).

TABLE 1

| | BLENDING AMOUNT [PARTS BY MASS] | | | | | | | | | | | | | | | | | |
|---|---|---|---|---|---|---|---|---|---|---|---|---|---|---|---|---|---|---|
| | SPECIFIC | | | | | | | | | | | | | | | | | |
| | DYE | | | | | | | | | | | | | | | | | |
| | DO | DB | ANIONIC DISPERSANT | | | | | | | MATERIAL A | | | | | | | | |
| | 25 | 27 | B1 | B2 | B3 | B4 | B5 | B6 | B7 | A1 | A2 | A3 | A4 | A5 | A6 | A7 | A8 | A9 |
| EXAMPLE | 15 | 0 | 15 | 0 | 0 | 0 | 0 | 0 | 0 | 0 | 0 | 1 | 0 | 0 | 0 | 0 | 1.5 | 0 |
| A1 | | | | | | | | | | | | | | | | | | |
| EXAMPLE | 0 | 15 | 15 | 0 | 0 | 0 | 0 | 0 | 0 | 0 | 0 | 1 | 0 | 0 | 0 | 0 | 1.5 | 0 |
| A2 | | | | | | | | | | | | | | | | | | |
| EXAMPLE | 7.5 | 7.5 | 15 | 0 | 0 | 0 | 0 | 0 | 0 | 0 | 0 | 1 | 0 | 0 | 0 | 0 | 1.5 | 0 |
| A3 | | | | | | | | | | | | | | | | | | |
| EXAMPLE | 15 | 0 | 15 | 0 | 0 | 0 | 0 | 0 | 0 | 0 | 0 | 1 | 0 | 0 | 0 | 0 | 0 | 0 |
| A4 | | | | | | | | | | | | | | | | | | |
| EXAMPLE | 15 | 0 | 15 | 0 | 0 | 0 | 0 | 0 | 0 | 0 | 0 | 0 | 0 | 0 | 0 | 0 | 1.5 | 0 |
| A5 | | | | | | | | | | | | | | | | | | |
| EXAMPLE | 15 | 0 | 15 | 0 | 0 | 0 | 0 | 0 | 0 | 0 | 0 | 1 | 0 | 0 | 1.5 | 0 | 0 | 0 |
| A6 | | | | | | | | | | | | | | | | | | |
| EXAMPLE | 15 | 0 | 15 | 0 | 0 | 0 | 0 | 0 | 0 | 0 | 0 | 1 | 0 | 0 | 0 | 1.5 | 0 | 0 |
| A7 | | | | | | | | | | | | | | | | | | |
| EXAMPLE | 15 | 0 | 15 | 0 | 0 | 0 | 0 | 0 | 0 | 0 | 0 | 1 | 0 | 0 | 0 | 0 | 0 | 1.5 |
| A8 | | | | | | | | | | | | | | | | | | |
| EXAMPLE | 15 | 0 | 15 | 0 | 0 | 0 | 0 | 0 | 0 | 0 | 0 | 1 | 0 | 0 | 0 | 0 | 0 | 0 |
| A9 | | | | | | | | | | | | | | | | | | |
| EXAMPLE | 15 | 0 | 15 | 0 | 0 | 0 | 0 | 0 | 0 | 0 | 0 | 1 | 0 | 0 | 0 | 0 | 0 | 0 |
| A10 | | | | | | | | | | | | | | | | | | |
| EXAMPLE | 15 | 0 | 15 | 0 | 0 | 0 | 0 | 0 | 0 | 0 | 0 | 1 | 0 | 0 | 0 | 0 | 0 | 0 |
| A11 | | | | | | | | | | | | | | | | | | |
| EXAMPLE | 15 | 0 | 15 | 0 | 0 | 0 | 0 | 0 | 0 | 0 | 0 | 1 | 0 | 0 | 0 | 0 | 0 | 0 |
| A12 | | | | | | | | | | | | | | | | | | |
| EXAMPLE | 15 | 0 | 15 | 0 | 0 | 0 | 0 | 0 | 0 | 0 | 0 | 1 | 0 | 0 | 0 | 0 | 0 | 0 |
| A13 | | | | | | | | | | | | | | | | | | |
| EXAMPLE | 15 | 0 | 15 | 0 | 0 | 0 | 0 | 0 | 0 | 0 | 0 | 1 | 0 | 0 | 0 | 0 | 0 | 0 |
| A14 | | | | | | | | | | | | | | | | | | |
| EXAMPLE | 15 | 0 | 0 | 15 | 0 | 0 | 0 | 0 | 0 | 0 | 0 | 1 | 0 | 0 | 0 | 0 | 1.5 | 0 |
| A15 | | | | | | | | | | | | | | | | | | |
| EXAMPLE | 15 | 0 | 0 | 0 | 15 | 0 | 0 | 0 | 0 | 0 | 0 | 1 | 0 | 0 | 0 | 0 | 1.5 | 0 |
| A16 | | | | | | | | | | | | | | | | | | |

| | BLENDING AMOUNT [PARTS BY MASS] | | | | | | | | | | | |
|---|---|---|---|---|---|---|---|---|---|---|---|---|
| | MATERIAL A | | | | | | DO | DO | DO | | | PURIFIED |
| | A10 | A11 | A12 | A13 | A14 | A15 | 11 | 119 | 15 | B′1 | A′1 | WATER |
| EXAMPLE | 0 | 0 | 0 | 0 | 0 | 0 | 0 | 0 | 0 | 0 | 0 | 67.5 |
| A1 | | | | | | | | | | | | |
| EXAMPLE | 0 | 0 | 0 | 0 | 0 | 0 | 0 | 0 | 0 | 0 | 0 | 67.5 |
| A2 | | | | | | | | | | | | |
| EXAMPLE | 0 | 0 | 0 | 0 | 0 | 0 | 0 | 0 | 0 | 0 | 0 | 67.5 |
| A3 | | | | | | | | | | | | |
| EXAMPLE | 0 | 0 | 0 | 0 | 0 | 0 | 0 | 0 | 0 | 0 | 0 | 69 |
| A4 | | | | | | | | | | | | |
| EXAMPLE | 0 | 0 | 0 | 0 | 0 | 0 | 0 | 0 | 0 | 0 | 0 | 68.5 |
| A5 | | | | | | | | | | | | |
| EXAMPLE | 0 | 0 | 0 | 0 | 0 | 0 | 0 | 0 | 0 | 0 | 0 | 67.5 |
| A6 | | | | | | | | | | | | |
| EXAMPLE | 0 | 0 | 0 | 0 | 0 | 0 | 0 | 0 | 0 | 0 | 0 | 67.5 |
| A7 | | | | | | | | | | | | |
| EXAMPLE | 0 | 0 | 0 | 0 | 0 | 0 | 0 | 0 | 0 | 0 | 0 | 54 |
| A8 | | | | | | | | | | | | |
| EXAMPLE | 1.5 | 0 | 0 | 0 | 0 | 0 | 0 | 0 | 0 | 0 | 0 | 54 |
| A9 | | | | | | | | | | | | |
| EXAMPLE | 0 | 1.5 | 0 | 0 | 0 | 0 | 0 | 0 | 0 | 0 | 0 | 54 |
| A10 | | | | | | | | | | | | |
| EXAMPLE | 0 | 0 | 1.5 | 0 | 0 | 0 | 0 | 0 | 0 | 0 | 0 | 67.5 |
| A11 | | | | | | | | | | | | |
| EXAMPLE | 0 | 0 | 0 | 1.5 | 0 | 0 | 0 | 0 | 0 | 0 | 0 | 67.5 |
| A12 | | | | | | | | | | | | |
| EXAMPLE | 0 | 0 | 0 | 0 | 1.5 | 0 | 0 | 0 | 0 | 0 | 0 | 67.5 |
| A13 | | | | | | | | | | | | |
| EXAMPLE | 0 | 0 | 0 | 0 | 0 | 1.5 | 0 | 0 | 0 | 0 | 0 | 67.5 |
| A14 | | | | | | | | | | | | |
| EXAMPLE | 0 | 0 | 0 | 0 | 0 | 0 | 0 | 0 | 0 | 0 | 0 | 67.5 |
| A15 | | | | | | | | | | | | |
| EXAMPLE | 0 | 0 | 0 | 0 | 0 | 0 | 0 | 0 | 0 | 0 | 0 | 67.5 |
| A16 | | | | | | | | | | | | |

TABLE 2

| | BLENDING AMOUNT [PARTS BY MASS] | | | | | | | | | | | | | | | | | |
|---|---|---|---|---|---|---|---|---|---|---|---|---|---|---|---|---|---|---|
| | SPECIFIC | | | | | | | | | | | | | | | | | |
| | DYE | | | | | | | | | | | | | | | | | |
| | DO | DB | ANIONIC DISPERSANT | | | | | | | MATERIAL A | | | | | | | | |
| | 25 | 27 | B1 | B2 | B3 | B4 | B5 | B6 | B7 | A1 | A2 | A3 | A4 | A5 | A6 | A7 | A8 | A9 |
| EXAMPLE | 15 | 0 | 0 | 0 | 0 | 15 | 0 | 0 | 0 | 0 | 0 | 1 | 0 | 0 | 0 | 0 | 1.5 | 0 |
| A17 | | | | | | | | | | | | | | | | | | |
| EXAMPLE | 15 | 0 | 0 | 0 | 0 | 0 | 15 | 0 | 0 | 0 | 0 | 1 | 0 | 0 | 0 | 0 | 1.5 | 0 |
| A18 | | | | | | | | | | | | | | | | | | |
| EXAMPLE | 15 | 0 | 0 | 0 | 0 | 0 | 0 | 15 | 0 | 0 | 0 | 1 | 0 | 0 | 0 | 0 | 1.5 | 0 |
| A19 | | | | | | | | | | | | | | | | | | |
| EXAMPLE | 15 | 0 | 0 | 0 | 0 | 0 | 0 | 0 | 15 | 0 | 0 | 1 | 0 | 0 | 0 | 0 | 1.5 | 0 |
| A20 | | | | | | | | | | | | | | | | | | |
| EXAMPLE | 15 | 0 | 5 | 0 | 0 | 0 | 0 | 5 | 5 | 0 | 0 | 1 | 0 | 0 | 0 | 0 | 1.5 | 0 |
| A21 | | | | | | | | | | | | | | | | | | |
| EXAMPLE | 15 | 0 | 15 | 0 | 0 | 0 | 0 | 0 | 0 | 1 | 0 | 0 | 0 | 0 | 0 | 0 | 1.5 | 0 |
| A22 | | | | | | | | | | | | | | | | | | |
| EXAMPLE | 15 | 0 | 15 | 0 | 0 | 0 | 0 | 0 | 0 | 0 | 1 | 0 | 0 | 0 | 0 | 0 | 1.5 | 0 |
| A23 | | | | | | | | | | | | | | | | | | |
| EXAMPLE | 15 | 0 | 15 | 0 | 0 | 0 | 0 | 0 | 0 | 0 | 0 | 0 | 1 | 0 | 0 | 0 | 1.5 | 0 |
| A24 | | | | | | | | | | | | | | | | | | |
| EXAMPLE | 15 | 0 | 15 | 0 | 0 | 0 | 0 | 0 | 0 | 0 | 0 | 0 | 0 | 1 | 0 | 0 | 1.5 | 0 |
| A25 | | | | | | | | | | | | | | | | | | |
| EXAMPLE | 15 | 0 | 6 | 0 | 0 | 0 | 0 | 0 | 0 | 0 | 0 | 1 | 0 | 0 | 0 | 0 | 1.5 | 0 |
| A26 | | | | | | | | | | | | | | | | | | |
| EXAMPLE | 15 | 0 | 30 | 0 | 0 | 0 | 0 | 0 | 0 | 0 | 0 | 1 | 0 | 0 | 0 | 0 | 1.5 | 0 |
| A27 | | | | | | | | | | | | | | | | | | |
| EXAMPLE | 15 | 0 | 3 | 0 | 0 | 0 | 0 | 0 | 0 | 0 | 0 | 1 | 0 | 0 | 0 | 0 | 1.5 | 0 |
| A28 | | | | | | | | | | | | | | | | | | |
| EXAMPLE | 15 | 0 | 35 | 0 | 0 | 0 | 0 | 0 | 0 | 0 | 0 | 1 | 0 | 0 | 0 | 0 | 1.5 | 0 |
| A29 | | | | | | | | | | | | | | | | | | |
| EXAMPLE | 15 | 0 | 15 | 0 | 0 | 0 | 0 | 0 | 0 | 0 | 0 | 0.4 | 0 | 0 | 0 | 0 | 0.4 | 0 |
| A30 | | | | | | | | | | | | | | | | | | |
| EXAMPLE | 15 | 0 | 15 | 0 | 0 | 0 | 0 | 0 | 0 | 0 | 0 | 15 | 0 | 0 | 0 | 0 | 15 | 0 |
| A31 | | | | | | | | | | | | | | | | | | |
| EXAMPLE | 15 | 0 | 15 | 0 | 0 | 0 | 0 | 0 | 0 | 0 | 0 | 0.25 | 0 | 0 | 0 | 0 | 0.25 | 0 |
| A32 | | | | | | | | | | | | | | | | | | |

| | BLENDING AMOUNT [PARTS BY MASS] | | | | | | | | | | | |
|---|---|---|---|---|---|---|---|---|---|---|---|---|
| | MATERIAL A | | | | | | DO | DO | DO | | | PURIFIED |
| | A10 | A11 | A12 | A13 | A14 | A15 | 11 | 119 | 15 | B′1 | A′1 | WATER |
| EXAMPLE | 0 | 0 | 0 | 0 | 0 | 0 | 0 | 0 | 0 | 0 | 0 | 67.5 |
| A17 | | | | | | | | | | | | |
| EXAMPLE | 0 | 0 | 0 | 0 | 0 | 0 | 0 | 0 | 0 | 0 | 0 | 67.5 |
| A18 | | | | | | | | | | | | |
| EXAMPLE | 0 | 0 | 0 | 0 | 0 | 0 | 0 | 0 | 0 | 0 | 0 | 67.5 |
| A19 | | | | | | | | | | | | |
| EXAMPLE | 0 | 0 | 0 | 0 | 0 | 0 | 0 | 0 | 0 | 0 | 0 | 67.5 |
| A20 | | | | | | | | | | | | |
| EXAMPLE | 0 | 0 | 0 | 0 | 0 | 0 | 0 | 0 | 0 | 0 | 0 | 67.5 |
| A21 | | | | | | | | | | | | |
| EXAMPLE | 0 | 0 | 0 | 0 | 0 | 0 | 0 | 0 | 0 | 0 | 0 | 67.5 |
| A22 | | | | | | | | | | | | |
| EXAMPLE | 0 | 0 | 0 | 0 | 0 | 0 | 0 | 0 | 0 | 0 | 0 | 67.5 |
| A23 | | | | | | | | | | | | |
| EXAMPLE | 0 | 0 | 0 | 0 | 0 | 0 | 0 | 0 | 0 | 0 | 0 | 67.5 |
| A24 | | | | | | | | | | | | |
| EXAMPLE | 0 | 0 | 0 | 0 | 0 | 0 | 0 | 0 | 0 | 0 | 0 | 67.5 |
| A25 | | | | | | | | | | | | |
| EXAMPLE | 0 | 0 | 0 | 0 | 0 | 0 | 0 | 0 | 0 | 0 | 0 | 76.5 |
| A26 | | | | | | | | | | | | |
| EXAMPLE | 0 | 0 | 0 | 0 | 0 | 0 | 0 | 0 | 0 | 0 | 0 | 52.5 |
| A27 | | | | | | | | | | | | |
| EXAMPLE | 0 | 0 | 0 | 0 | 0 | 0 | 0 | 0 | 0 | 0 | 0 | 79.5 |
| A28 | | | | | | | | | | | | |
| EXAMPLE | 0 | 0 | 0 | 0 | 0 | 0 | 0 | 0 | 0 | 0 | 0 | 47.5 |
| A29 | | | | | | | | | | | | |
| EXAMPLE | 0 | 0 | 0 | 0 | 0 | 0 | 0 | 0 | 0 | 0 | 0 | 69.2 |
| A30 | | | | | | | | | | | | |
| EXAMPLE | 0 | 0 | 0 | 0 | 0 | 0 | 0 | 0 | 0 | 0 | 0 | 40 |
| A31 | | | | | | | | | | | | |
| EXAMPLE | 0 | 0 | 0 | 0 | 0 | 0 | 0 | 0 | 0 | 0 | 0 | 69.5 |
| A32 | | | | | | | | | | | | |

TABLE 3

| | BLENDING AMOUNT [PARTS BY MASS] | | | | | | | | | | | | | | | | | |
|---|---|---|---|---|---|---|---|---|---|---|---|---|---|---|---|---|---|---|
| | SPECIFIC | | | | | | | | | | | | | | | | | |
| | DYE | | | | | | | | | | | | | | | | | |
| | DO | DB | ANIONIC DISPERSANT | | | | | | | MATERIAL A | | | | | | | | |
| | 25 | 27 | B1 | B2 | B3 | B4 | B5 | B6 | B7 | A1 | A2 | A3 | A4 | A5 | A6 | A7 | A8 | A9 |
| EXAMPLE A33 | 15 | 0 | 15 | 0 | 0 | 0 | 0 | 0 | 0 | 0 | 0 | 17.5 | 0 | 0 | 0 | 0 | 17.5 | 0 |
| EXAMPLE A34 | 15 | 0 | 30 | 0 | 0 | 0 | 0 | 0 | 0 | 0 | 0 | 0.35 | 0 | 0 | 0 | 0 | 0.35 | 0 |
| EXAMPLE A35 | 15 | 0 | 7.5 | 0 | 0 | 0 | 0 | 0 | 0 | 0 | 0 | 11.25 | 0 | 0 | 0 | 0 | 11.25 | 0 |
| EXAMPLE A36 | 15 | 0 | 30 | 0 | 0 | 0 | 0 | 0 | 0 | 0 | 0 | 0.2 | 0 | 0 | 0 | 0 | 0.2 | 0 |
| EXAMPLE A37 | 15 | 0 | 7.5 | 0 | 0 | 0 | 0 | 0 | 0 | 0 | 0 | 12.5 | 0 | 0 | 0 | 0 | 12.5 | 0 |
| COMPARATIVE | 15 | 0 | 15 | 0 | 0 | 0 | 0 | 0 | 0 | 0 | 0 | 0 | 0 | 0 | 0 | 0 | 0 | 0 |
| EXAMPLE A1 | | | | | | | | | | | | | | | | | | |
| COMPARATIVE | 0 | 0 | 15 | 0 | 0 | 0 | 0 | 0 | 0 | 0 | 0 | 1 | 0 | 0 | 0 | 0 | 1.5 | 0 |
| EXAMPLE A2 | | | | | | | | | | | | | | | | | | |
| COMPARATIVE | 15 | 0 | 15 | 0 | 0 | 0 | 0 | 0 | 0 | 0 | 0 | 1 | 0 | 0 | 0 | 0 | 0 | 0 |
| EXAMPLE A3 | | | | | | | | | | | | | | | | | | |
| COMPARATIVE | 15 | 0 | 15 | 0 | 0 | 0 | 0 | 0 | 0 | 0 | 0 | 1 | 0 | 0 | 0 | 0 | 0 | 0 |
| EXAMPLE A4 | | | | | | | | | | | | | | | | | | |
| COMPARATIVE | 15 | 0 | 0 | 0 | 0 | 0 | 0 | 0 | 0 | 0 | 0 | 1 | 0 | 0 | 0 | 0 | 1.5 | 0 |
| EXAMPLE A5 | | | | | | | | | | | | | | | | | | |
| COMPARATIVE | 15 | 0 | 15 | 0 | 0 | 0 | 0 | 0 | 0 | 0 | 0 | 0 | 0 | 0 | 0 | 0 | 1.5 | 0 |
| EXAMPLE A6 | | | | | | | | | | | | | | | | | | |

| | BLENDING AMOUNT [PARTS BY MASS] | | | | | | | | | | | |
|---|---|---|---|---|---|---|---|---|---|---|---|---|
| | MATERIAL A | | | | | | DO | DO | DO | | | PURIFIED |
| | A10 | A11 | A12 | A13 | A14 | A15 | 11 | 119 | 15 | B′1 | A′1 | WATER |
| EXAMPLE A33 | 0 | 0 | 0 | 0 | 0 | 0 | 0 | 0 | 0 | 0 | 0 | 35 |
| EXAMPLE A34 | 0 | 0 | 0 | 0 | 0 | 0 | 0 | 0 | 0 | 0 | 0 | 54.3 |
| EXAMPLE A35 | 0 | 0 | 0 | 0 | 0 | 0 | 0 | 0 | 0 | 0 | 0 | 55 |
| EXAMPLE A36 | 0 | 0 | 0 | 0 | 0 | 0 | 0 | 0 | 0 | 0 | 0 | 54.8 |
| EXAMPLE A37 | 0 | 0 | 0 | 0 | 0 | 0 | 0 | 0 | 0 | 0 | 0 | 52.5 |
| COMPARATIVE | 0 | 0 | 0 | 0 | 0 | 0 | 0 | 0 | 0 | 0 | 0 | 70 |
| EXAMPLE A1 | | | | | | | | | | | | |
| COMPARATIVE | 0 | 0 | 0 | 0 | 0 | 0 | 15 | 0 | 0 | 0 | 0 | 67.5 |
| EXAMPLE A2 | | | | | | | | | | | | |
| COMPARATIVE | 0 | 0 | 0 | 0 | 0 | 0 | 0 | 1.5 | 0 | 0 | 0 | 67.5 |
| EXAMPLE A3 | | | | | | | | | | | | |
| COMPARATIVE | 0 | 0 | 0 | 0 | 0 | 0 | 0 | 0 | 1.5 | 0 | 0 | 67.5 |
| EXAMPLE A4 | | | | | | | | | | | | |
| COMPARATIVE | 0 | 0 | 0 | 0 | 0 | 0 | 0 | 0 | 0 | 15 | 0 | 67.5 |
| EXAMPLE A5 | | | | | | | | | | | | |
| COMPARATIVE | 0 | 0 | 0 | 0 | 0 | 0 | 0 | 0 | 0 | 0 | 1 | 67.5 |
| EXAMPLE A6 | | | | | | | | | | | | |

TABLE 4

| | XB/XD | XA/XD | XA/XB |
|---|---|---|---|
| EXAMPLE A1 | 1.00 | 0.17 | 0.17 |
| EXAMPLE A2 | 1.00 | 0.17 | 0.17 |
| EXAMPLE A3 | 1.00 | 0.17 | 0.17 |
| EXAMPLE A4 | 1.00 | 0.07 | 0.07 |
| EXAMPLE A5 | 1.00 | 0.10 | 0.10 |
| EXAMPLE A6 | 1.00 | 0.17 | 0.17 |
| EXAMPLE A7 | 1.00 | 0.17 | 0.17 |
| EXAMPLE A8 | 1.00 | 0.17 | 0.17 |
| EXAMPLE A9 | 1.00 | 0.17 | 0.17 |
| EXAMPLE A10 | 1.00 | 0.17 | 0.17 |
| EXAMPLE A11 | 1.00 | 0.17 | 0.17 |
| EXAMPLE A12 | 1.00 | 0.17 | 0.17 |
| EXAMPLE A13 | 1.00 | 0.17 | 0.17 |
| EXAMPLE A14 | 1.00 | 0.17 | 0.17 |
| EXAMPLE A15 | 1.00 | 0.17 | 0.17 |
| EXAMPLE A16 | 1.00 | 0.17 | 0.17 |
| EXAMPLE A17 | 1.00 | 0.17 | 0.17 |
| EXAMPLE A18 | 1.00 | 0.17 | 0.17 |
| EXAMPLE A19 | 1.00 | 0.17 | 0.17 |
| EXAMPLE A20 | 1.00 | 0.17 | 0.17 |
| EXAMPLE A21 | 1.00 | 0.17 | 0.17 |
| EXAMPLE A22 | 1.00 | 0.17 | 0.17 |
| EXAMPLE A23 | 1.00 | 0.17 | 0.17 |
| EXAMPLE A24 | 1.00 | 0.17 | 0.17 |

TABLE 5

| | XB/XD | XA/XD | XA/XB |
|---|---|---|---|
| EXAMPLE A25 | 1.00 | 0.17 | 0.17 |
| EXAMPLE A26 | 0.40 | 0.17 | 0.42 |
| EXAMPLE A27 | 2.00 | 0.17 | 0.08 |
| EXAMPLE A28 | 0.20 | 0.17 | 0.83 |
| EXAMPLE A29 | 2.33 | 0.17 | 0.07 |
| EXAMPLE A30 | 1.00 | 0.05 | 0.05 |
| EXAMPLE A31 | 1.00 | 2.00 | 2.00 |
| EXAMPLE A32 | 1.00 | 0.03 | 0.03 |
| EXAMPLE A33 | 1.00 | 2.33 | 2.33 |
| EXAMPLE A34 | 2.00 | 0.05 | 0.02 |
| EXAMPLE A35 | 0.50 | 1.50 | 3.00 |
| EXAMPLE A36 | 2.00 | 0.03 | 0.01 |
| EXAMPLE A37 | 0.50 | 1.67 | 3.33 |
| COMPARATIVE EXAMPLE A1 | 1.00 | 0.00 | 0.00 |
| COMPARATIVE EXAMPLE A2 | — | — | 0.17 |
| COMPARATIVE EXAMPLE A3 | 1.00 | 0.07 | 0.07 |
| COMPARATIVE EXAMPLE A4 | 1.00 | 0.07 | 0.07 |
| COMPARATIVE EXAMPLE A5 | 0.00 | 0.17 | — |
| COMPARATIVE EXAMPLE A6 | 1.00 | 0.10 | 0.10 |

[4] Evaluation of Stock Solutioin for Ink-Jet Ink Production
[4-1] Change in Particle Diameter

After the average particle diameter of the dye immediately after the production and the average particle diameter of the dye which was contained in a predetermined container and was then left for one week in an environment at 60° C. were obtained from the stock solution for ink-jet ink production of each of Examples and Comparative Examples, from the values thus obtained, the rate of change of the average particle diameter of the dye which was left for one week in an environment at 60° C. to the average particle diameter of the dye immediately after the production was obtained, and evaluation was performed in accordance with the following criteria. In addition, in Examples A1 to A37 and Comparative Examples A1 and A3 to A6, the specific dye was used as a dye, the average particle diameter of which was to be measured, and in Comparative Example A2, C.I. Disperse Orange 11 was used as a dye, the average particle diameter of which was to be measured. In addition, for the measurement of the average particle diameter, a Microtrac UPA (manufactured by Nikkiso Co., Ltd.) was used. It can be said that when the rate of change in average particle diameter is high, the storage stability is low. C or higher was evaluated as a preferable level.
A: Rate of change in average particle diameter of less than 5%.
B: Rate of change in average particle diameter of 5% to less than 10%.
C: Rate of change in average particle diameter of 10% to less than 15%.
D: Rate of change in average particle diameter of 15% to less than 20%.
E: Rate of change in average particle diameter of 20% or more.
[4-2] Generation of Foreign Materials

First, 10 mL of the stock solution for ink-jet ink production of each of Examples and Comparative Examples was received in a predetermined glass bottle so that a gas-liquid interface existed and was then left for five days in an environment at 60° C. Subsequently, after the stock solution for ink-jet ink production was filtrated by a metal mesh filter having an opening diameter of 10 μm, the number of solid materials remaining on the metal mesh filer per square millimeter was counted, and evaluation was performed in accordance with the following criteria. It can be said that when the amount of foreign materials thus generated is large, the storage stability is low. C or higher was evaluated as a preferable level.

A: The number of solid materials per square millimeter is less than 5.
B: The number of solid materials per square millimeter is 5 to less than 10.
C: The number of solid materials per square millimeter is 10 to less than 30.
D: The number of solid materials per square millimeter is 30 to less than 50.
E: The number of solid materials per square millimeter is 50 or more.

Those results are collectively shown in Tables 6 and 7.

TABLE 6

| | CHANGE IN | GENERATION |
|---|---|---|
| | PARTICLE | OF FOREIGN |
| | DIAMETER | MATERIALS |
| EXAMPLE A1 | A | A |
| EXAMPLE A2 | A | A |
| EXAMPLE A3 | A | A |
| EXAMPLE A4 | C | C |
| EXAMPLE A5 | C | C |
| EXAMPLE A6 | A | A |
| EXAMPLE A7 | A | A |
| EXAMPLE A8 | B | B |
| EXAMPLE A9 | B | A |
| EXAMPLE A10 | B | B |
| EXAMPLE A11 | C | B |
| EXAMPLE A12 | C | B |
| EXAMPLE A13 | C | B |
| EXAMPLE A14 | C | A |
| EXAMPLE A15 | A | A |
| EXAMPLE A16 | A | A |
| EXAMPLE A17 | A | A |
| EXAMPLE A18 | A | A |
| EXAMPLE A19 | A | A |
| EXAMPLE A20 | A | A |
| EXAMPLE A21 | A | A |
| EXAMPLE A22 | A | C |
| EXAMPLE A23 | A | C |
| EXAMPLE A24 | A | C |

TABLE 7

| | CHANGE IN | GENERATION |
|---|---|---|
| | PARTICLE | OF FOREIGN |
| | DIAMETER | MATERIALS |
| EXAMPLE A25 | A | C |
| EXAMPLE A26 | C | B |
| EXAMPLE A27 | B | C |
| EXAMPLE A28 | C | B |
| EXAMPLE A29 | B | C |
| EXAMPLE A30 | A | A |
| EXAMPLE A31 | A | A |
| EXAMPLE A32 | B | B |
| EXAMPLE A33 | B | B |
| EXAMPLE A34 | A | A |
| EXAMPLE A35 | A | A |
| EXAMPLE A36 | C | C |
| EXAMPLE A37 | C | C |
| COMPARATIVE EXAMPLE A1 | E | E |
| COMPARATIVE EXAMPLE A2 | E | E |
| COMPARATIVE EXAMPLE A3 | E | E |
| COMPARATIVE EXAMPLE A4 | E | E |
| COMPARATIVE EXAMPLE A5 | E | E |
| COMPARATIVE EXAMPLE A6 | E | E |

As apparent from Tables 6 and 7, according to the present disclosure, excellent results are obtained. On the other hand, in Comparative Examples, satisfactory results are not obtained.
[5-1] Preparation of Ink-Jet Ink as Aqueous Ink Jet Composition

### Example B1

The stock solution for ink-jet ink production prepared in Example Al, glycerin, propylene glycol, BYK-348 as a silicone-based surfactant (manufactured by BYK Japan KK), and purified water were mixed together at a predetermined ratio, followed by stirring and mixing, so that an ink-jet ink having the composition shown in Table 8 was formed as the aqueous ink jet composition.

The average particle diameter of the specific dye in the ink-jet ink was 150 nm.

### Examples B2 to B37

Except for that the types of stock solutions for ink-jet ink production were changed so as to have the compositions as shown in Tables 8, 9, and 10, ink-jet inks were each formed as the aqueous ink jet composition in a manner similar to that of Example B1.

### Example B38

First, C.I. Disperse Orange 25 as the specific dye, a sodium methylnaphthalenesulfonate formalin condensate as the anionic dispersant, C.I. Disperse Orange 73, Newpole PE-108 as a polyethylene glycol having a weight average molecular weight of 16,000, C.I. Disperse Blue 360, C.I. Disperse Yellow 54, C.I. Solvent Orange 60, glycerin, propylene glycol, BYK-348 (manufactured by BYK Japan KK) as a silicone-based surfactant, and purified water were mixed at a ratio shown in Table 10, followed by stirring at 3,000 rpm by a High Shear Mixer (manufactured by Silverson Machines Inc.), so that a slurry was prepared. C.I. Disperse Orange 73 and Newpole PE-108 were each the material A.

Subsequently, the slurry thus formed and glass beads having a diameter of 0.5 mm were dispersed and stirred under water cooling conditions by a bead mill (LMZ015, manufactured by Ashizawa Finetech Ltd.), so that an ink-jet ink having the composition as shown in Table 10 was formed as the aqueous ink jet composition.

The average particle diameter of the specific dye in the ink-jet ink was 150 nm.

### Example B39

Except for that as the specific dye, C.I. Disperse Brown 27 was used instead of using C.I. Disperse Orange 25, an ink-jet ink was formed as the aqueous ink jet composition in a manner similar to that of Example B38.

### Comparative Examples B1 TO B6

Except for that the types of stock solutions for ink-jet ink production were changed to have the compositions shown in Table 10, ink-jet inks were each formed as the aqueous ink jet composition in a manner similar to that of Example B1.

### Comparative Example B7

First, C.I. Disperse Orange 25 as the specific dye, a sodium methylnaphthalenesulfonate formalin condensate as the anionic dispersant, C.I. Disperse Blue 360, C.I. Disperse Yellow 54, C.I. Solvent Orange 60, glycerin, propylene glycol, BYK-348 (manufactured by BYK Japan KK) as a silicone-based surfactant, and purified water were mixed at a ratio shown in Table 10, followed by stirring at 3,000 rpm by a High Shear Mixer (manufactured by Silverson Machines Inc.), so that a slurry was prepared.

Subsequently, the slurry thus formed and glass beads having a diameter of 0.5 mm were dispersed and stirred under water cooling conditions by a bead mill (LMZ015, manufactured by Ashizawa Finetech Ltd.), so that an ink-jet ink having the composition as shown in Table 10 was formed as the aqueous ink jet composition.

The average particle diameter of the specific dye in the ink-jet ink was 150 nm.

### Comparative Example B8

Except for that as the specific dye, C.I. Disperse Brown 27 was used instead of using C.I. Disperse Orange 25, an ink-jet ink was formed as the aqueous ink jet composition in a manner similar to that of Example B7.

The conditions of the ink-jet inks of the above Examples and Comparative Examples are collectively shown in Tables 8, 9, and 10. In addition, in the ink-jet ink, when the content of the material A, the content of the anionic dispersant, and the content of the specific dye are represented by XA [percent by mass], XB [percent by mass], and XD [percent by mass], respectively, values of XB/XD, XA/XD, and XA/XB are shown in Tables 11 and 12. In addition, in the tables, C.I. Disperse Orange 25 is represented by “DO25”, and C.I. Disperse Brown 27 is represented by “DB27”; a sodium methylnaphthalenesulfonate formalin condensate as the anionic dispersant is represented by “B1”, a sodium ethylnaphthalenesulfonate formalin condensate as the anionic dispersant is represented by “B2”, a sodium propylnaphthalenesulfonate formalin condensate as the anionic dispersant is represented by “B3”, a sodium butylnaphthalenesulfonate formalin condensate as the anionic dispersant is represented by “B4”, a sodium naphthalenesulfonate formalin condensate as the anionic dispersant is represented by “B5”, a sodium ligninsulfonate as the anionic dispersant is represented by “B6”, and a styrene-sodium styrenesulfonate copolymer as the anionic dispersant is represented by “B7”; a polyethylene glycol, that is, Newpole PE-34 (manufactured by Sanyo Chemical Industries, Ltd.) as a component forming the material A, is represented by “A1”, a polyethylene glycol, that is, Newpole PE-68 (manufactured by Sanyo Chemical Industries, Ltd.) as a component forming the material A, is represented by “A2”, a polyethylene glycol, that is, Newpole PE-108 (manufactured by Sanyo Chemical Industries, Ltd.) as a component forming the material A, is represented by “A3”, a polyethylene glycol, that is, Newpole PE-128 (manufactured by Sanyo Chemical Industries, Ltd.) as a component forming the material A, is represented by “A4”, a polyethylene glycol derivative, that is, NIKKOL PBC-34 (manufactured by Nikko Chemicals Co., Ltd.) as a component forming the material A, is represented by “A5”, a phenyl azo compound different from the specific dye, that is, C.I. Disperse Orange 30 as a component forming the material A is represented by “A6”, a phenyl azo compound different from the specific dye, that is, C.I. Disperse Orange 31 as a component forming the material A is represented by “A7”, a phenyl azo compound different from the specific dye, that is, C.I. Disperse Orange 73 as a component forming the material A is represented by “A8”, a phenyl azo compound different from the specific dye, that is, C.I. Disperse Orange 3 as a component forming the material A is represented by “A9”, a phenyl azo compound different from the specific dye, that is, C.I. Direct Orange 85 as a component forming the material A is represented by “A10”, a phenyl azo compound different from the specific dye, that is, C.I. Reactive Orange 84 as a component forming the material A is represented by “A11”, a phenyl azo compound different from the specific dye, that is, C.I. Acid Orange 7 as a component forming the material A is represented by “A12”, a phenyl azo compound different from the specific dye, that is, C.I. Acid Orange 10 as a component forming the material A is represented by “A13”, a phenyl azo compound different from the specific dye, that is, C.I. Acid Orange 56 as a component forming the material A is represented by “A14”, and a phenyl azo compound different from the specific dye, that is, C.I. Acid Yellow 17 as a component forming the material A is represented by “A15”; glycerin is represented by “Gly”, propylene glycol is represented by “PG”, BYK-348 (manufactured by BYK Japan KK) as a silicone-based surfactant is represented by “BYK348”, C.I. Disperse Blue 360 is represented by “DB360”, C.I. Disperse Yellow 54 is represented by “DY54”, and C.I. Solvent Orange 60 is represented by “SO60”; C.I. Disperse Orange 11 which is a dye other than the phenyl azo compound is represented by “DO11”, C.I. Disperse Orange 119 which is a dye other than the phenyl azo compound is represented by “DO119”, and C.I. Disperse Orange 15 which is a dye other than the phenyl azo compound is represented by “DO15”; and a polyoxyethylene sorbitan fatty acid ester (Solbon T-40, manufactured by Toho Chemical Industry Co., Ltd.) as a nonionic dispersant is represented by “B′1”, and a polycarboxylic acid-based surfactant (Carrybon L-400, manufactured by Sanyo Chemical Industries, Ltd.) is represented by “A′1”. In addition, the viscosities of the ink-jet inks of Examples B1 to B39 were in a range of 2.0 to 10 mPa·s, and the surface tensions thereof were in a range of 25 to 35 mN/m. In addition, the viscosity was measured at 25° C. using a viscoelastic tester MCR-300 (manufactured by Pysica) such that the shear rate was increased from 10 [s⁻¹] to 1,000 [s⁻¹], and a viscosity at a shear rate of 200 was read. In addition, the surface tension was measured at 25° C. by Wilhelmy method using a surface tension meter (CBVP-7, manufactured by Kyowa Interface Science Co., Ltd.).

TABLE 8

| | BLENDING AMOUNT [PARTS BY MASS] | | | | | | | | | | | | | | | | | | | | | |
|---|---|---|---|---|---|---|---|---|---|---|---|---|---|---|---|---|---|---|---|---|---|---|
| | SPECIFIC | | | | | | | | | | | | | | | | | | | | | |
| | DYE | | | | | | | | | | | | | | | | | | | | | |
| | DO | DB | ANIONIC DISPERSANT | | | | | | | MATERIAL A | | | | | | | | | | | | |
| | 25 | 27 | B1 | B2 | B3 | B4 | B5 | B6 | B7 | A1 | A2 | A3 | A4 | A5 | A6 | A7 | A8 | A9 | A10 | A11 | A12 | A13 |
| EXAMPLE | 5 | 0 | 5 | 0 | 0 | 0 | 0 | 0 | 0 | 0 | 0 | 0.33 | 0 | 0 | 0 | 0 | 0.5 | 0 | 0 | 0 | 0 | 0 |
| B1 | | | | | | | | | | | | | | | | | | | | | | |
| EXAMPLE | 0 | 5 | 5 | 0 | 0 | 0 | 0 | 0 | 0 | 0 | 0 | 0.33 | 0 | 0 | 0 | 0 | 0.5 | 0 | 0 | 0 | 0 | 0 |
| B2 | | | | | | | | | | | | | | | | | | | | | | |
| EXAMPLE | 2.5 | 2.5 | 5 | 0 | 0 | 0 | 0 | 0 | 0 | 0 | 0 | 0.33 | 0 | 0 | 0 | 0 | 0.5 | 0 | 0 | 0 | 0 | 0 |
| B3 | | | | | | | | | | | | | | | | | | | | | | |
| EXAMPLE | 5 | 0 | 5 | 0 | 0 | 0 | 0 | 0 | 0 | 0 | 0 | 0.33 | 0 | 0 | 0 | 0 | 0 | 0 | 0 | 0 | 0 | 0 |
| B4 | | | | | | | | | | | | | | | | | | | | | | |
| EXAMPLE | 5 | 0 | 5 | 0 | 0 | 0 | 0 | 0 | 0 | 0 | 0 | 0 | 0 | 0 | 0 | 0 | 0.5 | 0 | 0 | 0 | 0 | 0 |
| B5 | | | | | | | | | | | | | | | | | | | | | | |
| EXAMPLE | 5 | 0 | 5 | 0 | 0 | 0 | 0 | 0 | 0 | 0 | 0 | 0.33 | 0 | 0 | 0.5 | 0 | 0 | 0 | 0 | 0 | 0 | 0 |
| B6 | | | | | | | | | | | | | | | | | | | | | | |
| EXAMPLE | 5 | 0 | 5 | 0 | 0 | 0 | 0 | 0 | 0 | 0 | 1 | 0.33 | 0 | 0 | 0 | 0.5 | 0 | 0 | 0 | 0 | 0 | 0 |
| B7 | | | | | | | | | | | | | | | | | | | | | | |
| EXAMPLE | 5 | 0 | 5 | 0 | 0 | 0 | 0 | 0 | 0 | 0 | 0 | 0.33 | 0 | 0 | 0 | 0 | 0 | 0.5 | 0 | 0 | 0 | 0 |
| B8 | | | | | | | | | | | | | | | | | | | | | | |
| EXAMPLE | 5 | 0 | 5 | 0 | 0 | 0 | 0 | 0 | 0 | 0 | 0 | 0.33 | 0 | 0 | 0 | 0 | 0 | 0 | 0.5 | 0 | 0 | 0 |
| B9 | | | | | | | | | | | | | | | | | | | | | | |
| EXAMPLE | 5 | 0 | 5 | 0 | 0 | 0 | 0 | 0 | 0 | 0 | 0 | 0.33 | 0 | 0 | 0 | 0 | 0 | 0 | 0 | 0.5 | 0 | 0 |
| B10 | | | | | | | | | | | | | | | | | | | | | | |
| EXAMPLE | 5 | 0 | 5 | 0 | 0 | 0 | 0 | 0 | 0 | 0 | 0 | 0.33 | 0 | 0 | 0 | 0 | 0 | 0 | 0 | 0 | 0.5 | 0 |
| B11 | | | | | | | | | | | | | | | | | | | | | | |
| EXAMPLE | 5 | 0 | 5 | 0 | 0 | 0 | 0 | 0 | 0 | 0 | 0 | 0.33 | 0 | 0 | 0 | 0 | 0 | 0 | 0 | 0 | 0 | 0.5 |
| B12 | | | | | | | | | | | | | | | | | | | | | | |
| EXAMPLE | 5 | 0 | 5 | 0 | 0 | 0 | 0 | 0 | 0 | 0 | 0 | 0.33 | 0 | 0 | 0 | 0 | 0 | 0 | 0 | 0 | 0 | 0 |
| B13 | | | | | | | | | | | | | | | | | | | | | | |
| EXAMPLE | 5 | 0 | 5 | 0 | 0 | 0 | 0 | 0 | 0 | 0 | 0 | 0.33 | 0 | 0 | 0 | 0 | 0 | 0 | 0 | 0 | 0 | 0 |
| B14 | | | | | | | | | | | | | | | | | | | | | | |
| EXAMPLE | 5 | 0 | 0 | 5 | 0 | 0 | 0 | 0 | 0 | 0 | 0 | 0.33 | 0 | 0 | 0 | 0 | 0.5 | 0 | 0 | 0 | 0 | 0 |
| B15 | | | | | | | | | | | | | | | | | | | | | | |
| EXAMPLE | 5 | 0 | 0 | 0 | 5 | 0 | 0 | 0 | 0 | 0 | 0 | 0.33 | 0 | 0 | 0 | 0 | 0.5 | 0 | 0 | 0 | 0 | 0 |
| B16 | | | | | | | | | | | | | | | | | | | | | | |
| EXAMPLE | 5 | 0 | 0 | 0 | 0 | 5 | 0 | 0 | 0 | 0 | 0 | 0.33 | 0 | 0 | 0 | 0 | 0.5 | 0 | 0 | 0 | 0 | 0 |
| B17 | | | | | | | | | | | | | | | | | | | | | | |
| EXAMPLE | 5 | 0 | 0 | 0 | 0 | 0 | 5 | 0 | 0 | 0 | 0 | 0.33 | 0 | 0 | 0 | 0 | 0.5 | 0 | 0 | 0 | 0 | 0 |
| B18 | | | | | | | | | | | | | | | | | | | | | | |

| | BLENDING AMOUNT [PARTS BY MASS] | | | | | | | | | | | | | |
|---|---|---|---|---|---|---|---|---|---|---|---|---|---|---|
| | | | SOLVENT | | | | | | | | | | | |
| | | | OTHER THAN | | | OTHER COMPONENTS | | | | | | | | |
| | MATERIAL A | | WATER | | SURFACTANT | DB | DY | SO | DO | DO | DO | | | PURIFIED |
| | A14 | A15 | Gly | PG | BYK 348 | 360 | 54 | 60 | 11 | 119 | 15 | B′1 | A′1 | WATER |
| EXAMPLE | 0 | 0 | 15 | 10 | 0.5 | 0 | 0 | 0 | 0 | 0 | 0 | 0 | 0 | 63.67 |
| B1 | | | | | | | | | | | | | | |
| EXAMPLE | 0 | 0 | 15 | 10 | 0.5 | 0 | 0 | 0 | 0 | 0 | 0 | 0 | 0 | 63.67 |
| B2 | | | | | | | | | | | | | | |
| EXAMPLE | 0 | 0 | 15 | 10 | 0.5 | 0 | 0 | 0 | 0 | 0 | 0 | 0 | 0 | 63.67 |
| B3 | | | | | | | | | | | | | | |
| EXAMPLE | 0 | 0 | 15 | 10 | 0.5 | 0 | 0 | 0 | 0 | 0 | 0 | 0 | 0 | 64.17 |
| B4 | | | | | | | | | | | | | | |
| EXAMPLE | 0 | 0 | 15 | 10 | 0.5 | 0 | 0 | 0 | 0 | 0 | 0 | 0 | 0 | 64 |
| B5 | | | | | | | | | | | | | | |
| EXAMPLE | 0 | 0 | 15 | 10 | 0.5 | 0 | 0 | 0 | 0 | 0 | 0 | 0 | 0 | 63.67 |
| B6 | | | | | | | | | | | | | | |
| EXAMPLE | 0 | 0 | 15 | 10 | 0.5 | 0 | 0 | 0 | 0 | 0 | 0 | 0 | 0 | 63.67 |
| B7 | | | | | | | | | | | | | | |
| EXAMPLE | 0 | 0 | 15 | 10 | 0.5 | 0 | 0 | 0 | 0 | 0 | 0 | 0 | 0 | 63.67 |
| B8 | | | | | | | | | | | | | | |
| EXAMPLE | 0 | 0 | 15 | 10 | 0.5 | 0 | 0 | 0 | 0 | 0 | 0 | 0 | 0 | 63.67 |
| B9 | | | | | | | | | | | | | | |
| EXAMPLE | 0 | 0 | 15 | 10 | 0.5 | 0 | 0 | 0 | 0 | 0 | 0 | 0 | 0 | 63.67 |
| B10 | | | | | | | | | | | | | | |
| EXAMPLE | 0 | 0 | 15 | 10 | 0.5 | 0 | 0 | 0 | 0 | 0 | 0 | 0 | 0 | 63.67 |
| B11 | | | | | | | | | | | | | | |
| EXAMPLE | 0 | 0 | 15 | 10 | 0.5 | 0 | 0 | 0 | 0 | 0 | 0 | 0 | 0 | 63.67 |
| B12 | | | | | | | | | | | | | | |
| EXAMPLE | 0.5 | 0 | 15 | 10 | 0.5 | 0 | 0 | 0 | 0 | 0 | 0 | 0 | 0 | 63.67 |
| B13 | | | | | | | | | | | | | | |
| EXAMPLE | 0 | 0.5 | 15 | 10 | 0.5 | 0 | 0 | 0 | 0 | 0 | 0 | 0 | 0 | 63.67 |
| B14 | | | | | | | | | | | | | | |
| EXAMPLE | 0 | 0 | 15 | 10 | 0.5 | 0 | 0 | 0 | 0 | 0 | 0 | 0 | 0 | 63.67 |
| B15 | | | | | | | | | | | | | | |
| EXAMPLE | 0 | 0 | 15 | 10 | 0.5 | 0 | 0 | 0 | 0 | 0 | 0 | 0 | 0 | 63.67 |
| B16 | | | | | | | | | | | | | | |
| EXAMPLE | 0 | 0 | 15 | 10 | 0.5 | 0 | 0 | 0 | 0 | 0 | 0 | 0 | 0 | 63.67 |
| B17 | | | | | | | | | | | | | | |
| EXAMPLE | 0 | 0 | 15 | 10 | 0.5 | 0 | 0 | 0 | 0 | 0 | 0 | 0 | 0 | 63.67 |
| B18 | | | | | | | | | | | | | | |

TABLE 9

| | BLENDING AMOUNT [PARTS BY MASS] | | | | | | | | | | | | | | | | | | | | |
|---|---|---|---|---|---|---|---|---|---|---|---|---|---|---|---|---|---|---|---|---|---|
| | SPECIFIC | | | | | | | | | | | | | | | | | | | | |
| | DYE | | | | | | | | | | | | | | | | | | | | |
| | DO | DB | ANIONIC DISPERSANT | | | | | | | MATERIAL A | | | | | | | | | | | |
| | 25 | 27 | B1 | B2 | B3 | B4 | B5 | B6 | B7 | A1 | A2 | A3 | A4 | A5 | A6 | A7 | A8 | A9 | A10 | A11 | A12 |
| EXAMPLE | 5 | 0 | 0 | 0 | 0 | 0 | 0 | 5 | 0 | 0 | 0 | 0.33 | 0 | 0 | 0 | 0 | 0.5 | 0 | 0 | 0 | 0 |
| B19 | | | | | | | | | | | | | | | | | | | | | |
| EXAMPLE | 5 | 0 | 0 | 0 | 0 | 0 | 0 | 0 | 5 | 0 | 0 | 0.33 | 0 | 0 | 0 | 0 | 0.5 | 0 | 0 | 0 | 0 |
| B20 | | | | | | | | | | | | | | | | | | | | | |
| EXAMPLE | 5 | 0 | 1.67 | 0 | 0 | 0 | 0 | 1.67 | 1.67 | 0 | 0 | 0.33 | 0 | 0 | 0 | 0 | 0.5 | 0 | 0 | 0 | 0 |
| B21 | | | | | | | | | | | | | | | | | | | | | |
| EXAMPLE | 5 | 0 | 5 | 0 | 0 | 0 | 0 | 0 | 0 | 0.33 | 0 | 0 | 0 | 0 | 0 | 0 | 0.5 | 0 | 0 | 0 | 0 |
| B22 | | | | | | | | | | | | | | | | | | | | | |
| EXAMPLE | 5 | 0 | 5 | 0 | 0 | 0 | 0 | 0 | 0 | 0 | 0.33 | 0 | 0 | 0 | 0 | 0 | 0.5 | 0 | 0 | 0 | 0 |
| B23 | | | | | | | | | | | | | | | | | | | | | |
| EXAMPLE | 5 | 0 | 5 | 0 | 0 | 0 | 0 | 0 | 0 | 0 | 0 | 0 | 0.33 | 0 | 0 | 0 | 0.5 | 0 | 0 | 0 | 0 |
| B24 | | | | | | | | | | | | | | | | | | | | | |
| EXAMPLE | 5 | 0 | 5 | 0 | 0 | 0 | 0 | 0 | 0 | 0 | 0 | 0 | 0 | 0.33 | 0 | 0 | 0.5 | 0 | 0 | 0 | 0 |
| B25 | | | | | | | | | | | | | | | | | | | | | |
| EXAMPLE | 5 | 0 | 2 | 0 | 0 | 0 | 0 | 0 | 0 | 0 | 0 | 0.33 | 0 | 0 | 0 | 0 | 0.5 | 0 | 0 | 0 | 0 |
| B26 | | | | | | | | | | | | | | | | | | | | | |
| EXAMPLE | 5 | 0 | 10 | 0 | 0 | 0 | 0 | 0 | 0 | 0 | 0 | 0.33 | 0 | 0 | 0 | 0 | 0.5 | 0 | 0 | 0 | 0 |
| B27 | | | | | | | | | | | | | | | | | | | | | |
| EXAMPLE | 5 | 0 | 1 | 0 | 0 | 0 | 0 | 0 | 0 | 0 | 0 | 0.33 | 0 | 0 | 0 | 0 | 0.5 | 0 | 0 | 0 | 0 |
| B28 | | | | | | | | | | | | | | | | | | | | | |
| EXAMPLE | 5 | 0 | 11.7 | 0 | 0 | 0 | 0 | 0 | 0 | 0 | 0 | 0.33 | 0 | 0 | 0 | 0 | 0.5 | 0 | 0 | 0 | 0 |
| B29 | | | | | | | | | | | | | | | | | | | | | |
| EXAMPLE | 5 | 0 | 5 | 0 | 0 | 0 | 0 | 0 | 0 | 0 | 0 | 0.33 | 0 | 0 | 0 | 0 | 0.13 | 0 | 0 | 0 | 0 |
| B30 | | | | | | | | | | | | | | | | | | | | | |
| EXAMPLE | 5 | 0 | 5 | 0 | 0 | 0 | 0 | 0 | 0 | 0 | 0 | 5 | 0 | 0 | 0 | 0 | 5 | 0 | 0 | 0 | 0 |
| B31 | | | | | | | | | | | | | | | | | | | | | |
| EXAMPLE | 5 | 0 | 5 | 0 | 0 | 0 | 0 | 0 | 0 | 0 | 0 | 0.083 | 0 | 0 | 0 | 0 | 0.083 | 0 | 0 | 0 | 0 |
| B32 | | | | | | | | | | | | | | | | | | | | | |
| EXAMPLE | 5 | 0 | 5 | 0 | 0 | 0 | 0 | 0 | 0 | 0 | 0 | 5.83 | 0 | 0 | 0 | 0 | 5.83 | 0 | 0 | 0 | 0 |
| B33 | | | | | | | | | | | | | | | | | | | | | |
| EXAMPLE | 5 | 0 | 10 | 0 | 0 | 0 | 0 | 0 | 0 | 0 | 0 | 0.12 | 0 | 0 | 0 | 0 | 0.12 | 0 | 0 | 0 | 0 |
| B34 | | | | | | | | | | | | | | | | | | | | | |
| EXAMPLE | 5 | 0 | 2.5 | 0 | 0 | 0 | 0 | 0 | 0 | 0 | 0 | 3.75 | 0 | 0 | 0 | 0 | 3.75 | 0 | 0 | 0 | 0 |
| B35 | | | | | | | | | | | | | | | | | | | | | |
| EXAMPLE | 5 | 0 | 10 | 0 | 0 | 0 | 0 | 0 | 0 | 0 | 0 | 0.067 | 0 | 0 | 0 | 0 | 0.067 | 0 | 0 | 0 | 0 |
| B36 | | | | | | | | | | | | | | | | | | | | | |

| | BLENDING AMOUNT [PARTS BY MASS] | | | | | | | | | | | | | | |
|---|---|---|---|---|---|---|---|---|---|---|---|---|---|---|---|
| | | | | SOLVENT OTHER | | | OTHER COMPONENTS | | | | | | | | |
| | MATERIAL A | | | THAN WATER | | SURFACTANT | DB | DY | SO | DO | DO | DO | | | PURIFIED |
| | A13 | A14 | A15 | Gly | PG | BYK 348 | 360 | 54 | 60 | 11 | 119 | 15 | B′1 | A′1 | WATER |
| EXAMPLE | 0 | 0 | 0 | 15 | 10 | 0.5 | 0 | 0 | 0 | 0 | 0 | 0 | 0 | 0 | 63.67 |
| B19 | | | | | | | | | | | | | | | |
| EXAMPLE | 0 | 0 | 0 | 15 | 10 | 0.5 | 0 | 0 | 0 | 0 | 0 | 0 | 0 | 0 | 64.17 |
| B20 | | | | | | | | | | | | | | | |
| EXAMPLE | 0 | 0 | 0 | 15 | 10 | 0.5 | 0 | 0 | 0 | 0 | 0 | 0 | 0 | 0 | 63.66 |
| B21 | | | | | | | | | | | | | | | |
| EXAMPLE | 0 | 0 | 0 | 15 | 10 | 0.5 | 0 | 0 | 0 | 0 | 0 | 0 | 0 | 0 | 63.67 |
| B22 | | | | | | | | | | | | | | | |
| EXAMPLE | 0 | 0 | 0 | 15 | 10 | 0.5 | 0 | 0 | 0 | 0 | 0 | 0 | 0 | 0 | 63.67 |
| B23 | | | | | | | | | | | | | | | |
| EXAMPLE | 0 | 0 | 0 | 15 | 10 | 0.5 | 0 | 0 | 0 | 0 | 0 | 0 | 0 | 0 | 63.67 |
| B24 | | | | | | | | | | | | | | | |
| EXAMPLE | 0 | 0 | 0 | 15 | 10 | 0.5 | 0 | 0 | 0 | 0 | 0 | 0 | 0 | 0 | 63.67 |
| B25 | | | | | | | | | | | | | | | |
| EXAMPLE | 0 | 0 | 0 | 15 | 10 | 0.5 | 0 | 0 | 0 | 0 | 0 | 0 | 0 | 0 | 66.67 |
| B26 | | | | | | | | | | | | | | | |
| EXAMPLE | 0 | 0 | 0 | 15 | 10 | 0.5 | 0 | 0 | 0 | 0 | 0 | 0 | 0 | 0 | 58.67 |
| B27 | | | | | | | | | | | | | | | |
| EXAMPLE | 0 | 0 | 0 | 15 | 10 | 0.5 | 0 | 0 | 0 | 0 | 0 | 0 | 0 | 0 | 67.67 |
| B28 | | | | | | | | | | | | | | | |
| EXAMPLE | 0 | 0 | 0 | 15 | 10 | 0.5 | 0 | 0 | 0 | 0 | 0 | 0 | 0 | 0 | 56.97 |
| B29 | | | | | | | | | | | | | | | |
| EXAMPLE | 0 | 0 | 0 | 15 | 10 | 0.5 | 0 | 0 | 0 | 0 | 0 | 0 | 0 | 0 | 64.24 |
| B30 | | | | | | | | | | | | | | | |
| EXAMPLE | 0 | 0 | 0 | 15 | 10 | 0.5 | 0 | 0 | 0 | 0 | 0 | 0 | 0 | 0 | 54.5 |
| B31 | | | | | | | | | | | | | | | |
| EXAMPLE | 0 | 0 | 0 | 15 | 10 | 0.5 | 0 | 0 | 0 | 0 | 0 | 0 | 0 | 0 | 64.334 |
| B32 | | | | | | | | | | | | | | | |
| EXAMPLE | 0 | 0 | 0 | 15 | 10 | 0.5 | 0 | 0 | 0 | 0 | 0 | 0 | 0 | 0 | 52.84 |
| B33 | | | | | | | | | | | | | | | |
| EXAMPLE | 0 | 0 | 0 | 15 | 10 | 0.5 | 0 | 0 | 0 | 0 | 0 | 0 | 0 | 0 | 59.26 |
| B34 | | | | | | | | | | | | | | | |
| EXAMPLE | 0 | 0 | 0 | 15 | 10 | 0.5 | 0 | 0 | 0 | 0 | 0 | 0 | 0 | 0 | 59.5 |
| B35 | | | | | | | | | | | | | | | |
| EXAMPLE | 0 | 0 | 0 | 15 | 10 | 0.5 | 0 | 0 | 0 | 0 | 0 | 0 | 0 | 0 | 59.366 |
| B36 | | | | | | | | | | | | | | | |

TABLE 10

| | BLENDING AMOUNT [PARTS BY MASS] | | | | | | | | | | | | | | | | | | | | | |
|---|---|---|---|---|---|---|---|---|---|---|---|---|---|---|---|---|---|---|---|---|---|---|
| | SPECIFIC | | | | | | | | | | | | | | | | | | | | | |
| | DYE | | | | | | | | | | | | | | | | | | | | | |
| | DO | DB | ANIONIC DISPERSANT | | | | | | | MATERIAL A | | | | | | | | | | | | |
| | 25 | 27 | B1 | B2 | B3 | B4 | B5 | B6 | B7 | A1 | A2 | A3 | A4 | A5 | A6 | A7 | A8 | A9 | A10 | A11 | A12 | A13 |
| EXAMPLE B37 | 5 | 0 | 2.5 | 0 | 0 | 0 | 0 | 0 | 0 | 0 | 0 | 4.17 | 0 | 0 | 0 | 0 | 4.17 | 0 | 0 | 0 | 0 | 0 |
| EXAMPLE B38 | 2 | 0 | 3 | 0 | 0 | 0 | 0 | 0 | 0 | 0 | 0 | 0.33 | 0 | 0 | 0 | 0 | 0.5 | 0 | 0 | 0 | 0 | 0 |
| EXAMPLE B39 | 0 | 2 | 3 | 0 | 0 | 0 | 0 | 0 | 0 | 0 | 0 | 0.33 | 0 | 0 | 0 | 0 | 0.5 | 0 | 0 | 0 | 0 | 0 |
| COMPARATIVE | 5 | 0 | 5 | 0 | 0 | 0 | 0 | 0 | 0 | 0 | 0 | 0 | 0 | 0 | 0 | 0 | 0 | 0 | 0 | 0 | 0 | 0 |
| EXAMPLE B1 | | | | | | | | | | | | | | | | | | | | | | |
| COMPARATIVE | 0 | 0 | 5 | 0 | 0 | 0 | 0 | 0 | 0 | 0 | 0 | 0.33 | 0 | 0 | 0 | 0 | 0.5 | 0 | 0 | 0 | 0 | 0 |
| EXAMPLE B2 | | | | | | | | | | | | | | | | | | | | | | |
| COMPARATIVE | 5 | 0 | 5 | 0 | 0 | 0 | 0 | 0 | 0 | 0 | 0 | 0.33 | 0 | 0 | 0 | 0 | 0 | 0 | 0 | 0 | 0 | 0 |
| EXAMPLE B3 | | | | | | | | | | | | | | | | | | | | | | |
| COMPARATIVE | 5 | 0 | 5 | 0 | 0 | 0 | 0 | 0 | 0 | 0 | 0 | 0.33 | 0 | 0 | 0 | 0 | 0 | 0 | 0 | 0 | 0 | 0 |
| EXAMPLE B4 | | | | | | | | | | | | | | | | | | | | | | |
| COMPARATIVE | 5 | 0 | 0 | 0 | 0 | 0 | 0 | 0 | 0 | 0 | 0 | 0.33 | 0 | 0 | 0 | 0 | 0.5 | 0 | 0 | 0 | 0 | 0 |
| EXAMPLE B5 | | | | | | | | | | | | | | | | | | | | | | |
| COMPARATIVE | 5 | 0 | 5 | 0 | 0 | 0 | 0 | 0 | 0 | 0 | 0 | 0 | 0 | 0 | 0 | 0 | 0.5 | 0 | 0 | 0 | 0 | 0 |
| EXAMPLE B6 | | | | | | | | | | | | | | | | | | | | | | |
| COMPARATIVE | 2 | 0 | 3 | 0 | 0 | 0 | 0 | 0 | 0 | 0 | 0 | 0 | 0 | 0 | 0 | 0 | 0 | 0 | 0 | 0 | 0 | 0 |
| EXAMPLE B7 | | | | | | | | | | | | | | | | | | | | | | |
| COMPARATIVE | 0 | 2 | 3 | 0 | 0 | 0 | 0 | 0 | 0 | 0 | 0 | 0 | 0 | 0 | 0 | 0 | 0 | 0 | 0 | 0 | 0 | 0 |
| EXAMPLE B8 | | | | | | | | | | | | | | | | | | | | | | |

| | BLENDING AMOUNT [PARTS BY MASS] | | | | | | | | | | | | | |
|---|---|---|---|---|---|---|---|---|---|---|---|---|---|---|
| | | | SOLVENT OTHER | | | OTHER COMPONENTS | | | | | | | | |
| | MATERIAL A | | THAN WATER | | SURFACTANT | DB | DY | SO | DO | DO | DO | | | PURIFIED |
| | A14 | A15 | Gly | PG | BYK 348 | 360 | 54 | 60 | 11 | 119 | 15 | B′1 | A′1 | WATER |
| EXAMPLE B37 | 0 | 0 | 15 | 10 | 0.5 | 0 | 0 | 0 | 0 | 0 | 0 | 0 | 0 | 58.66 |
| EXAMPLE B38 | 0 | 0 | 15 | 10 | 0.5 | 2 | 0.5 | 1.5 | 0 | 0 | 0 | 0 | 0 | 64.67 |
| EXAMPLE B39 | 0 | 0 | 15 | 10 | 0.5 | 2 | 0.5 | 1.5 | 0 | 0 | 0 | 0 | 0 | 64.67 |
| COMPARATIVE | 0 | 0 | 15 | 10 | 0.5 | 0 | 0 | 0 | 0 | 0 | 0 | 0 | 0 | 64.5 |
| EXAMPLE B1 | | | | | | | | | | | | | | |
| COMPARATIVE | 0 | 0 | 15 | 10 | 0.5 | 0 | 0 | 0 | 5 | 0 | 0 | 0 | 0 | 63.34 |
| EXAMPLE B2 | | | | | | | | | | | | | | |
| COMPARATIVE | 0 | 0 | 15 | 10 | 0.5 | 0 | 0 | 0 | 0 | 0.5 | 0 | 0 | 0 | 63.34 |
| EXAMPLE B3 | | | | | | | | | | | | | | |
| COMPARATIVE | 0 | 0 | 15 | 10 | 0.5 | 0 | 0 | 0 | 0 | 0 | 0.5 | 0 | 0 | 63.34 |
| EXAMPLE B4 | | | | | | | | | | | | | | |
| COMPARATIVE | 0 | 0 | 15 | 10 | 0.5 | 0 | 0 | 0 | 0 | 0 | 0 | 5 | 0 | 68.34 |
| EXAMPLE B5 | | | | | | | | | | | | | | |
| COMPARATIVE | 0 | 0 | 15 | 10 | 0.5 | 0 | 0 | 0 | 0 | 0 | 0 | 0 | 0.33 | 63.67 |
| EXAMPLE B6 | | | | | | | | | | | | | | |
| COMPARATIVE | 0 | 0 | 15 | 10 | 0.5 | 2 | 0.5 | 1.5 | 0 | 0 | 0 | 0 | 0 | 65.5 |
| EXAMPLE B7 | | | | | | | | | | | | | | |
| COMPARATIVE | 0 | 0 | 15 | 10 | 0.5 | 2 | 0.5 | 1.5 | 0 | 0 | 0 | 0 | 0 | 65.5 |
| EXAMPLE B8 | | | | | | | | | | | | | | |

TABLE 11

| | XB/XD | XA/XD | XA/XB |
|---|---|---|---|
| EXAMPLE B1 | 1.00 | 0.17 | 0.17 |
| EXAMPLE B2 | 1.00 | 0.17 | 0.17 |
| EXAMPLE B3 | 1.00 | 0.17 | 0.17 |
| EXAMPLE B4 | 1.00 | 0.07 | 0.07 |
| EXAMPLE B5 | 1.00 | 0.10 | 0.10 |
| EXAMPLE B6 | 1.00 | 0.17 | 0.17 |
| EXAMPLE B7 | 1.00 | 0.17 | 0.17 |
| EXAMPLE B8 | 1.00 | 0.17 | 0.17 |
| EXAMPLE B9 | 1.00 | 0.17 | 0.17 |
| EXAMPLE B10 | 1.00 | 0.17 | 0.17 |
| EXAMPLE B11 | 1.00 | 0.17 | 0.17 |
| EXAMPLE B12 | 1.00 | 0.17 | 0.17 |
| EXAMPLE B13 | 1.00 | 0.17 | 0.17 |
| EXAMPLE B14 | 1.00 | 0.17 | 0.17 |
| EXAMPLE B15 | 1.00 | 0.17 | 0.17 |
| EXAMPLE B16 | 1.00 | 0.17 | 0.17 |
| EXAMPLE B17 | 1.00 | 0.17 | 0.17 |
| EXAMPLE B18 | 1.00 | 0.17 | 0.17 |
| EXAMPLE B19 | 1.00 | 0.17 | 0.17 |
| EXAMPLE B20 | 1.00 | 0.17 | 0.17 |
| EXAMPLE B21 | 1.00 | 0.17 | 0.17 |
| EXAMPLE B22 | 1.00 | 0.17 | 0.17 |
| EXAMPLE B23 | 1.00 | 0.17 | 0.17 |
| EXAMPLE B24 | 1.00 | 0.17 | 0.17 |

TABLE 12

| | XB/XD | XA/XD | XA/XB |
|---|---|---|---|
| EXAMPLE B25 | 1.00 | 0.17 | 0.17 |
| EXAMPLE B26 | 0.40 | 0.17 | 0.42 |
| EXAMPLE B27 | 2.00 | 0.17 | 0.08 |
| EXAMPLE B28 | 0.20 | 0.17 | 0.83 |
| EXAMPLE B29 | 2.34 | 0.17 | 0.07 |
| EXAMPLE B30 | 1.00 | 0.05 | 0.05 |
| EXAMPLE B31 | 1.00 | 2.00 | 2.00 |
| EXAMPLE B32 | 1.00 | 0.03 | 0.03 |
| EXAMPLE B33 | 1.00 | 2.33 | 2.33 |
| EXAMPLE B34 | 2.00 | 0.05 | 0.02 |
| EXAMPLE B35 | 0.50 | 1.50 | 3.00 |
| EXAMPLE B36 | 2.00 | 0.03 | 0.01 |
| EXAMPLE B37 | 0.50 | 1.67 | 3.34 |
| EXAMPLE B38 | 1.50 | 0.42 | 0.28 |
| EXAMPLE B39 | 1.50 | 0.42 | 0.28 |
| COMPARATIVE EXAMPLE B1 | 1.00 | 0.00 | 0.00 |
| COMPARATIVE EXAMPLE B2 | — | — | 0.17 |
| COMPARATIVE EXAMPLE B3 | 1.00 | 0.07 | 0.07 |
| COMPARATIVE EXAMPLE B4 | 1.00 | 0.07 | 0.07 |
| COMPARATIVE EXAMPLE B5 | 0.00 | 0.17 | — |
| COMPARATIVE EXAMPLE B6 | 1.00 | 0.10 | 0.10 |
| COMPARATIVE EXAMPLE B7 | 1.50 | 0.00 | 0.00 |
| COMPARATIVE EXAMPLE B8 | 1.50 | 0.00 | 0.00 |

[6] Evaluation of Ink-Jet Ink
[6-1] Change in Particle Diameter

After the average particle diameter of the dye immediately after the production and the average particle diameter of the dye which was contained in a predetermined ink container and was then left for one week in an environment at 60° C. were obtained from the ink-jet ink of each of Examples and Comparative Examples, from the values thus obtained, the rate of change of the average particle diameter of the dye which was left for one week in an environment at 60° C. to the average particle diameter of the dye immediately after the production was obtained, and evaluation was performed in accordance with the following criteria. In Examples B1 to B39 and Comparative Examples B1 and B3 to B8, the specific dye was used as a dye, the average particle diameter of which was to be measured, and in Comparative Example B2, C.I. Disperse Orange 11 was used as a dye, the average particle diameter of which was to be measured. In addition, for the measurement of the average particle diameter, a Microtrac UPA (manufactured by Nikkiso Co., Ltd.) was used. It can be said that when the rate of change in average particle diameter is high, the storage stability is low. C or higher was evaluated as a preferable level.

A: Rate of change in average particle diameter of less than 5%.
B: Rate of change in average particle diameter of 5% to less than 10%.
C: Rate of change in average particle diameter of 10% to less than 15%.
D: Rate of change in average particle diameter of 15% to less than 20%.
E: Rate of change in average particle diameter of 20% or more.
[6-2]. Generation of Foreign Materials

First, 10 mL of the ink-jet ink of each of Examples and Comparative Examples was received in a predetermined glass bottle so that a gas-liquid interface existed and was then left for five days in an environment at 60° C. Subsequently, after the ink-jet ink was filtrated by a metal mesh filter having an opening diameter of 10 μm, the number of solid materials remaining on the metal mesh filer per square millimeter was counted, and evaluation was performed in accordance with the following criteria. It can be said that when the amount of foreign materials thus generated is large, the storage stability is low. C or higher was evaluated as a preferable level.

A: The number of solid materials per square millimeter is less than 5.
B: The number of solid materials per square millimeter is 5 to less than 10.
C: The number of solid materials per square millimeter is 10 to less than 30.
D: The number of solid materials per square millimeter is 30 to less than 50.
E: The number of solid materials per square millimeter is 50 or more.
[6-3] Clogging Recovery Property

After the ink-jet ink of each of Examples and Comparative Examples was filled in a predetermined container, this container was fitted to PX-H6000 manufactured by Seiko Epson Corporation.

After normal ejection from all nozzles was confirmed, the recording apparatus under the normal condition was placed in an Off state and was then left for one month in an environment at 40° C.

Subsequently, the number of recovery operations performed by suction until the normal ejection was recovered was obtained, and evaluation was performed in accordance with the following criteria. C or higher was evaluated as a preferable level.

A: Normal ejection is performed immediately after the power source is placed in an ON state or by one to three recovery operations.
B: Normal ejection is performed by four to six recovery operations.
C: Normal ejection is performed by seven to nine recovery operations.
D: After nine recovery operations are performed, the apparatus is left at room temperature for 12 hours, and normal ejection is then performed by additional one to three recovery operations.
E: After nine recovery operations are performed, the apparatus is left at room temperature for 12 hours, and normal ejection is still not performed by additional three recovery operations.

Those results are shown in Tables 13 and 14.

TABLE 13

| | CHANGE IN | GENERATION | CLOGGING |
|---|---|---|---|
| | PARTICLE | OF FOREIGN | RECOVERY |
| | DIAMETER | MATERIALS | PROPERTY |
| EXAMPLE B1 | A | A | A |
| EXAMPLE B2 | A | A | A |
| EXAMPLE B3 | A | A | A |
| EXAMPLE B4 | C | C | C |
| EXAMPLE B5 | C | C | C |
| EXAMPLE B6 | A | A | A |
| EXAMPLE B7 | A | A | A |
| EXAMPLE B8 | B | B | B |
| EXAMPLE B9 | B | A | A |
| EXAMPLE B10 | B | B | B |
| EXAMPLE B11 | C | B | B |
| EXAMPLE B12 | C | B | B |
| EXAMPLE B13 | C | B | B |
| EXAMPLE B14 | C | B | B |
| EXAMPLE B15 | A | A | B |
| EXAMPLE B16 | A | A | B |
| EXAMPLE B17 | A | A | B |
| EXAMPLE B18 | A | A | B |
| EXAMPLE B19 | A | A | C |
| EXAMPLE B20 | A | A | C |
| EXAMPLE B21 | A | A | C |
| EXAMPLE B22 | A | C | C |
| EXAMPLE B23 | A | C | B |
| EXAMPLE B24 | A | C | B |

TABLE 14

| | CHANGE IN | GENERATION | CLOGGING |
|---|---|---|---|
| | PARTICLE | OF FOREIGN | RECOVERY |
| | DIAMETER | MATERIALS | PROPERTY |
| EXAMPLE B25 | A | C | C |
| EXAMPLE B26 | C | B | B |
| EXAMPLE B27 | B | C | B |
| EXAMPLE B28 | C | B | C |
| EXAMPLE B29 | B | C | A |
| EXAMPLE B30 | A | A | A |
| EXAMPLE B31 | A | A | B |
| EXAMPLE B32 | B | B | B |
| EXAMPLE B33 | B | B | C |
| EXAMPLE B34 | A | A | A |
| EXAMPLE B35 | A | A | B |
| EXAMPLE B36 | C | C | C |
| EXAMPLE B37 | C | C | C |
| EXAMPLE B38 | A | A | A |
| EXAMPLE B39 | A | A | A |
| COMPARATIVE | E | E | D |
| EXAMPLE B1 | | | |
| COMPARATIVE | E | E | D |
| EXAMPLE B2 | | | |
| COMPARATIVE | E | E | D |
| EXAMPLE B3 | | | |
| COMPARATIVE | E | E | D |
| EXAMPLE B4 | | | |
| COMPARATIVE | E | E | E |
| EXAMPLE B5 | | | |
| COMPARATIVE | E | E | D |
| EXAMPLE B6 | | | |
| COMPARATIVE | E | E | D |
| EXAMPLE B7 | | | |
| COMPARATIVE | E | E | D |
| EXAMPLE B8 | | | |

As apparent from Tables 13 and 14, according to the present disclosure, excellent results can be obtained. On the other hand, in Comparative Examples, satisfactory results cannot be obtained.

What is claimed is:

1. An aqueous ink jet composition comprising:
at least one specific dye selected from the group consisting of C.I. Disperse Orange 25 and C.I. Disperse Brown 27;
an anionic dispersant; and
a material A which is at least one compound selected from the group consisting of a polyalkylene glycol, a derivative thereof, and a phenyl azo compound different from the specific dye.

2. The aqueous ink jet composition according to claim 1,
wherein the anionic dispersant is at least one of a compound represented by the following formula (3), a sodium naphthalenesulfonate formalin condensate, a ligninsulfonic acid, and a styrene-sodium styrenesulfonate copolymer, 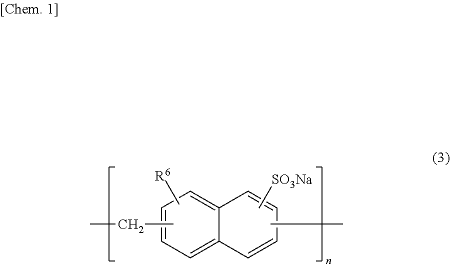
where in the formula (3), R⁶ indicates a hydrocarbon group having four carbon atoms or less, and n indicates an integer of 1 or more.

3. The aqueous ink jet composition according to claim 1,
wherein when a content of the specific dye is represented by XD [percent by mass], and a content of the anionic dispersant is represented by XB [percent by mass], 0.4XB/XD2.0.

4. The aqueous ink jet composition according to claim 1,
wherein when a content of the specific dye is represented by XD [percent by mass], and a content of the material A is represented by XA [percent by mass], 0.05XA/XD2.0.

5. The aqueous ink jet composition according to claim 1,
wherein when a content of the material A is represented by XA [percent by mass], and a content of the anionic dispersant is represented by XB [percent by mass], 0.02≤XA/XB≤3.0.

6. The aqueous ink jet composition according to claim 1,
wherein the anionic dispersant has a weight average molecular weight of 1,000 to 20,000.

7. The aqueous ink jet composition according to claim 1,
wherein the material A at least contains the polyalkylene glycol, and the polyalkylene glycol has a weight average molecular weight of 1,000 to 20,000.

8. The aqueous ink jet composition according to claim 1,
wherein the material A at least contains the phenyl azo compound, and the phenyl azo compound has a molar mass of 300 to 1,200.

9. The aqueous ink jet composition according to claim 1,
wherein the material A contains, as the phenyl azo compound, at least one selected from the group consisting of C.I. Disperse Orange 30, C.I. Disperse Orange 31, and C.I. Disperse Orange 73.

10. The aqueous ink jet composition according to claim 1, which is used in an air open-type recording apparatus.
